(19) United States
(12) Patent Application Publication
(10) Pub. No.: US 2026/0170136 A1
(43) Pub. Date: Jun. 18, 2026

(54) SYSTEMS AND METHODS TO ANALYZE MALWARE AND PRODUCE SAMPLES, TOOLS, AND DATASET FOR SECURITY EVALUATION

(71) Applicant: GEORGIA TECH RESEARCH CORPORATION, Atlanta, GA (US)

(72) Inventors: Wenke Lee, Atlanta, GA (US); Ding Zhang, Atlanta, GA (US); Zheng Yang, Atlanta, GA (US); Yupeng Yang, Atlanta, GA (US); Jizhou Chen, Atlanta, GA (US); Shenglong Yao, Atlanta, GA (US)

(21) Appl. No.: 19/424,050

(22) Filed: Dec. 17, 2025

Related U.S. Application Data
(60) Provisional application No. 63/735,301, filed on Dec. 17, 2024.

(51) Int. Cl. G06F 21/56

(52) U.S. Cl. CPC G06F 21/566; G06F 2221/033

(57) ABSTRACT

An exemplary system and method are disclosed for a scalable pipeline for automated, end-to-end malware analysis that (i) can replicate any existing or new malware with verified, ground-truth behaviors, and (ii) establish a standardized data, reliable database to store the behaviors of the replicated malwares, thereby facilitating controllability and reproducibility in malware analysis and detection. In some implementations, the exemplary system and method facilitate reproducible malware analysis by isolating behaviors from a malware sample, validating them against a set of behaviors, rewriting them to conform to the set, and categorizing them by complexity.

### RELATED APPLICATION

This application claims priority to, and the benefit of, U.S. Provisional Patent Application No. 63/735,301, filed Dec. 17, 2024, entitled “METHODS AND SYSTEMS TO ANALYZE MALWARE AND PRODUCE SAMPLES, TOOLS, AND DATASETS FOR SECURITY EVALUATION,” which is incorporated by reference herein in its entirety.

### BACKGROUND

Malware analysis is the process of studying malicious software to understand its functionality, origin, and impact. Analysts typically combine static analysis, dynamic execution in controlled environments, and in more advanced settings symbolic or concolic execution to explore behaviors hidden by obfuscation or environmental checks. A variety of specialized tools such as disassemblers, debuggers, sandboxes, and memory analysis utilities support these workflows and enable the development and evaluation of effective defenses.

As cybersecurity threats become more sophisticated, there is a benefit to improving security analysis systems to detect and analyze the full spectrum of malicious actions a malware sample may exhibit.

### SUMMARY

An exemplary system and method are disclosed for a scalable pipeline for automated, end-to-end malware analysis that (i) can replicate any existing or new malwares with verified, ground-truth behaviors, and (ii) establish a standardized data, reliable database (referred to as a taxonomy behavior database) to store the behaviors of the replicated malwares, thereby facilitating controllability and reproducibility in malware analysis. In some implementations, the exemplary system and method facilitate reproducible malware analysis by isolating behaviors from a malware sample, validating them against a set of behaviors, rewriting them to conform to the set, and categorizing them by complexity.

The field of malware behavior analysis lacks a standardized dataset of malware samples whose behaviors have been analyzed and verified, which limits the ability to evaluate and benchmark malware analysis and security monitoring systems. Current security analysis systems have the aim of identifying specific behaviors rather than to document complete behavioral profiles of malware, which can result in partial analyses in which the accuracy, reproducibility, and completeness of the discovered behaviors are uncertain. Current analysis may also entail a company sending its security team to a third-party vendor location for assessment in a custom-built environment that may simulate the company's setup to some degree (but not 100%). In contrast, the exemplary system and method can provide comprehensive behavioral profiling and continuous, in-house security assessment using newly generated, verifiable malware samples, eliminating reliance on third-party assessments and ensuring accurate, scalable, and transparent testing outcomes.

The exemplary system and method can be applied to various cybersecurity applications. The exemplary system and method can be configured as a benchmark for evaluating malware analysis systems by providing a standardized dataset of malware samples with verified behaviors, facilitating the measurement and comparison of detection accuracy. The exemplary system and method can support the evaluation of various security technologies (e.g., firewalls, intrusion detection systems), ensuring they can detect and respond to real-world threats. The exemplary system and method can also be configured as an educational platform for cybersecurity training, facilitating safe, hands-on study of malware behaviors and attack patterns. By fostering collaborative analysis and providing structured behavioral taxonomies, the exemplary system and method can facilitate coordinated efforts among enterprises, researchers, and government agencies to track evolving security threats. The behavioral data generated by the exemplary system and method can also be used to train artificial-intelligence-driven (AI-driven) malware detection systems and synthesize new malware samples for defense testing, advancing innovation and resilience across the cybersecurity industry.

In an aspect, a system is disclosed comprising: a processor; and a memory having instructions stored thereon for a pipeline operation to (i) extract malware behaviors through an analysis of real-world malware samples and (ii) utilize confirmed execution traces and required external inputs to replicate the traces accurately, wherein execution of the instructions by the processor causes the processor to: receive malware computer-readable instructions as a malware sample; determine (e.g., via one or more AI modules), whether the received malware sample requires a concolic analysis; execute the concolic analysis in a first execution environment based on the determination, to determine concolic analysis results including a first set of malware behaviors represented through a first set of execution traces; generate one or more external inputs based on the first set of execution traces in the concolic analysis results; execute the received malware sample in a second execution environment to generate a second set of execution traces using the received malware sample and generated external inputs, wherein the second set of execution traces represents a second set of malware behaviors; compare the second set of execution traces to the first set of execution traces to compare the second set of malware behaviors to the first set of malware behaviors to determine a set of verified behaviors for the received malware sample; generate new malware computer-readable instructions by removing a portion of the malware computer-readable instructions or regenerating malware computer-readable instructions through a source code to generate a new rewritten malware sample, wherein the new rewritten malware sample is modified and compared in an iterative manner until a set of behaviors of the new rewritten malware sample matches the verified behavior via comparison of newly generated second sets of execution traces to the first set of execution traces; and output the new rewritten malware sample, wherein the output is subsequently employed for studies on malware behaviors and/or generation of behavioral signatures for a detection of the malware and its variants.

In some embodiments, the AI modules are implemented using neural networks, machine learning (ML) models, or other artificial intelligence (AI) models. In some embodiments, the AI modules are implemented using LLM agents, AI agents, or ML agents. In some embodiments, the AI modules are encapsulated within the AI tools, ML tools, or software tools.

In some embodiments, in response to the newly generated second set of execution traces not matching the first set of execution traces, the execution of the instructions causes the processor to: determine (e.g., via the one or more AI modules), adjustments for concolic analysis and iteratively re-perform concolic analysis to re-generate a third set of execution traces, re-generate external input, and re-execute to re-generate a fourth set of execution traces in the second execution environment, and redo the comparison of the fourth set of execution traces to the third set of execution traces, until they match.

In some embodiments, the instructions to generate new malware computer-readable instructions are executed by a binary rewriter and a source-code rewriter, and the new malware computer-readable instructions are generated as a binary object, a source code object, or a combination thereof.

In some embodiments, the instructions by the processor to determine whether the malware sample requires concolic analysis comprise: instructions to execute a triage operation having a pipeline operation configured to: receive, via one or more processes, the malware sample; modify, via the one or more processes, the malware sample, wherein the modification includes unpacking, disabling binary base, removing anti-analysis behaviors, or reducing loops; determine, via the one or more processes, properties of the malware sample; generate, via the one or more processes, reports of the modification and the determined properties; and determine, via a rule-based engine, an initiation of the execution of the concolic analysis based on the modification and the determined properties.

In some embodiments, the pipeline operation further causes the processor to: receive (e.g., via the one or more AI modules) results of the modification and the determined properties; determine (e.g., via the one or more AI modules) a request for (i) additional modifications of the malware sample, (ii) additional determinations of the properties of the malware sample, or (iii) a reinitialization of the pipeline operation, wherein the determined request follows predefined safety constraints and bounds; and execute the pipeline operation, or a step thereof, based on the determined request.

In some embodiments, the pipeline is a static pipeline operation, an agentic AI pipeline operation, or a combination thereof.

In some embodiments, the execution of the concolic analysis causes the processor to: receive the malware sample and configuration files to configure the first environment; execute the malware sample in the first environment to explore multiple paths; generate the first set of execution traces based on the execution of the malware sample, wherein the first set of execution traces includes one or more execution symbolic variables with constraints; and solve the constraints to determine concolic parameters for the concolic analysis, wherein the concolic parameters are subsequently stored in a concolic database.

In some embodiments, the generation of one or more external inputs causes the processor to: receive the first set of execution traces, and the one or more execution symbol variables therein, from the concolic analysis results; receive one or more configuration parameters of the second execution environment; and generate task files or network packets as the one or more external inputs, using the received one or more configuration parameters and the received first set of execution traces, or the execution symbol variables therein, wherein the generated task files or network packets configure the second set of malware behaviors represented by the second set of execution traces.

In some embodiments, the comparison of the second set of execution traces to the first set of execution traces causes the processor to: determine a match between logic block sequences in the second set of execution traces and logic block sequences in the first set of execution traces; determine a match between function calls in the second set of execution traces and function calls in the first set of execution traces; and determine, a match between system events caused by the second set of execution traces and system events caused by the first set of execution traces.

In some embodiments, the rewriting of the malware sample causes the processor to: disassemble, via the binary rewriter, the malware sample to locate executable instructions therein; determine, via the binary rewriter, executed instructions within the executable instructions based on the second set of execution traces; modify, via the binary rewriter, the executable instructions by rewriting unexecuted instructions from the executable instructions with exception-triggering instructions, wherein execution of the executable instructions in the malware sample terminates when reaching the exception-triggering instructions; prompt, via the source-code rewriter, one or more AI modules with one or more implementation constraints to generate source code; compile, via the source-code rewriter, generated source code to generate the new rewritten malware sample; execute, via the source-code rewriter, the new rewritten malware sample to obtain the newly generated second set of execution traces that represent the set of behaviors of the new rewritten malware sample; iteratively rewrite, via the source-code rewriter, the generated source code until the set of behaviors of the new rewritten malware sample matches the verified behavior; and output the new rewritten malware sample, wherein the new rewritten malware sample is constrained to exhibit only the verified behavior.

In some embodiments, the execution of the instructions further causes the processor to: categorize the new malware sample based on a complexity of the second set of malware behaviors.

In some embodiments, the execution of the instructions by the processor causes the processor to execute a second pipeline operation, the second pipeline operation having a subset of the pipeline operation.

In some embodiments, the system described herein further comprises: a behavior database configured to store different behaviors of analyzed malware sample families.

In some embodiments, the behavior database is established based on the categorization of the malware sample based on a malware family value, a discovered date value, a complexity value, a behavior value, or a combination thereof.

In some embodiments, the behavior database is subsequently used in an AI or ML training pipeline configured to train one or more AI or ML models for malware detection, malware classification, and malware attribution.

In some embodiments, the system includes an LLM agent.

In some embodiments, the system includes an LLM, AI model, a machine-learning model, or a combination thereof.

In some embodiments, the system is implemented and/or deployed in a distributed infrastructure.

In another aspect, a non-transitory computer-readable medium having instructions stored thereon is disclosed, wherein execution of the instructions causes a processor to: receive malware computer-readable instructions as a malware sample; determine (e.g., via one or more AI modules) whether the received malware sample requires a concolic analysis; execute the concolic analysis in a first execution environment based on the determination, to determine concolic analysis results including a first set of malware behaviors represented through a first set of execution traces; generate one or more external inputs based on the first set of execution traces in the concolic analysis results; execute the received malware sample in a second execution environment to generate a second set of execution traces using the received malware sample and generated external inputs, wherein the second set of execution traces represents a second set of malware behaviors; compare the second set of execution traces to the first set of execution traces to compare the second set of malware behaviors to the first set of malware behaviors to determine a set of verified behaviors for the received malware sample; generate new malware computer-readable instructions by removing a portion of the malware computer-readable instructions or regenerating malware computer-readable instructions through a source code to generate a new rewritten malware sample, wherein the new rewritten malware sample is modified and compared in an iterative manner until a set of behaviors of the new rewritten malware sample matches the verified behavior via comparison of newly generated second sets of execution traces to the first set of execution traces; and output the new malware sample, wherein the output is subsequently employed for studies on malware behaviors and/or generation of behavioral signatures for a detection of the malware and its variants.

In yet another aspect, a method for a pipeline operation to (i) extract malware behaviors through an analysis of real-world malware samples and (ii) utilize confirmed execution traces and required external inputs to replicate the traces accurately is disclosed comprising: receiving malware computer-readable instructions as a malware sample; determining (e.g., via one or more AI modules) whether the received malware sample requires a concolic analysis; executing the concolic analysis in a first execution environment based on the determination, to determine concolic analysis results including a first set of malware behaviors represented through a first set of execution traces; generating one or more external inputs based on the first set of execution traces in the concolic analysis results; executing the received malware sample in a second execution environment to generate a second set of execution traces using the received malware sample and generated external inputs, wherein the second set of execution traces represents a second set of malware behaviors; comparing the second set of execution traces to the first set of execution traces to compare the second set of malware behaviors to the first set of malware behaviors to determine a set of verified behaviors for the received malware sample; generating new malware computer-readable instructions by removing a portion of the malware computer-readable instructions or regenerating malware computer-readable instructions through a source code to generate a new rewritten malware sample, wherein the new rewritten malware sample is modified and compared in an iterative manner until a set of behaviors of the new rewritten malware sample matches the verified behavior via comparison of newly generated second sets of execution traces to the first set of execution traces; and outputting the new malware sample, wherein the output is subsequently employed for studies on malware behaviors and/or generation of behavioral signatures for a detection of the malware and its variants.

### BRIEF DESCRIPTION OF DRAWINGS

FIGS. 1A-1C each shows an example malware analysis and replication system for (i) extracting malware behaviors through an analysis of real-world malware samples and (ii) replicating or modifying the malware behaviors depending on the malware analysis needs, in accordance with an illustrative embodiment.

FIG. 2 shows an example operation method for a pipeline operation of the exemplary system, in accordance with an illustrative embodiment.

FIGS. 3A-3E show example configurations for a triage module, a concolic analysis module, a rewriter module, a verifier module, and a taxonomy module of the exemplary system, respectively, in accordance with an illustrative embodiment.

FIGS. 4A-4B show an experimental malware analysis and replication system (described in FIGS. 1-3) and its associated operation flows.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

### Example System

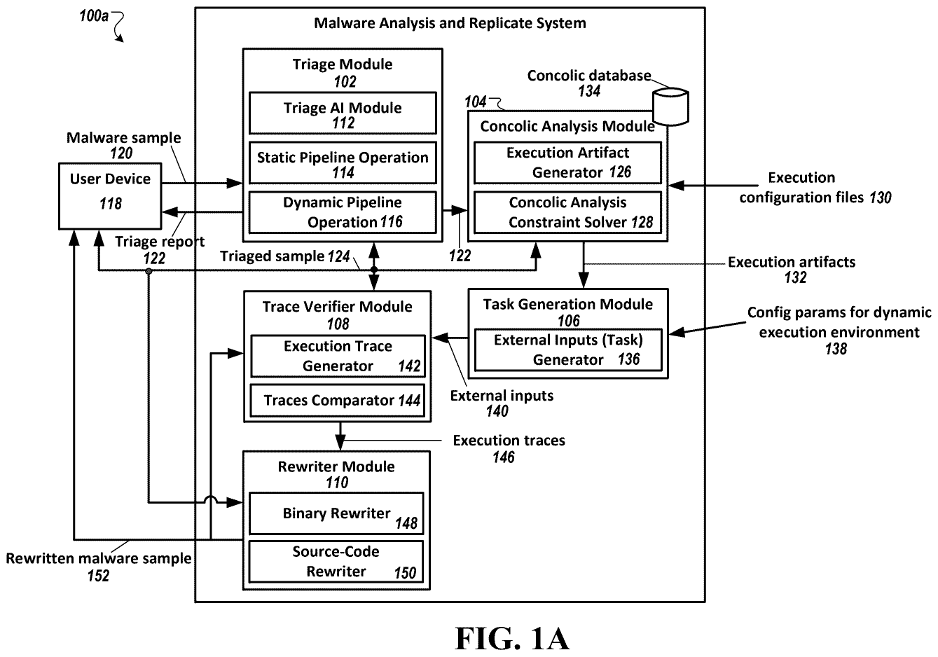

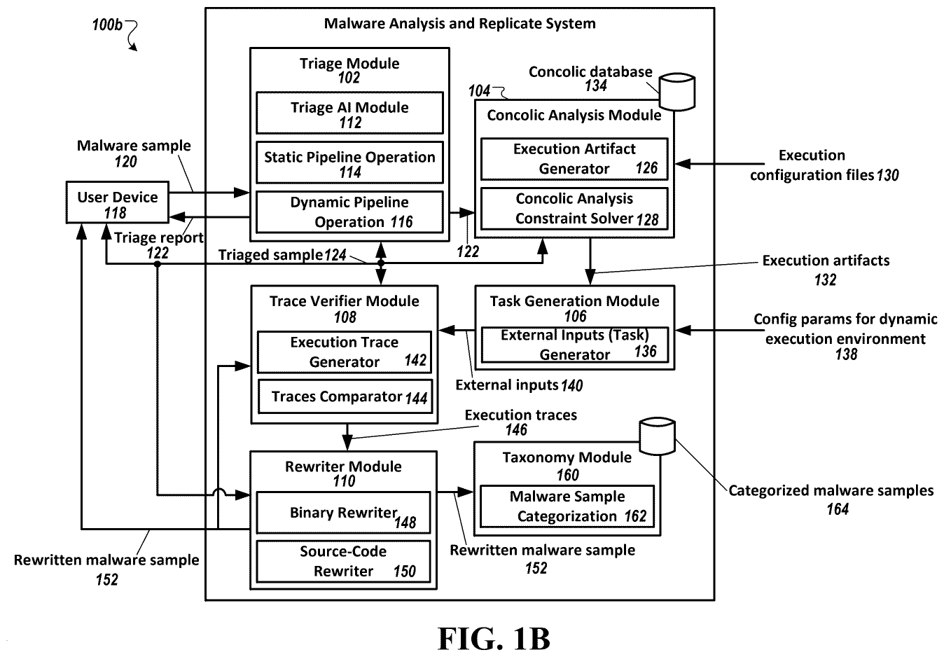

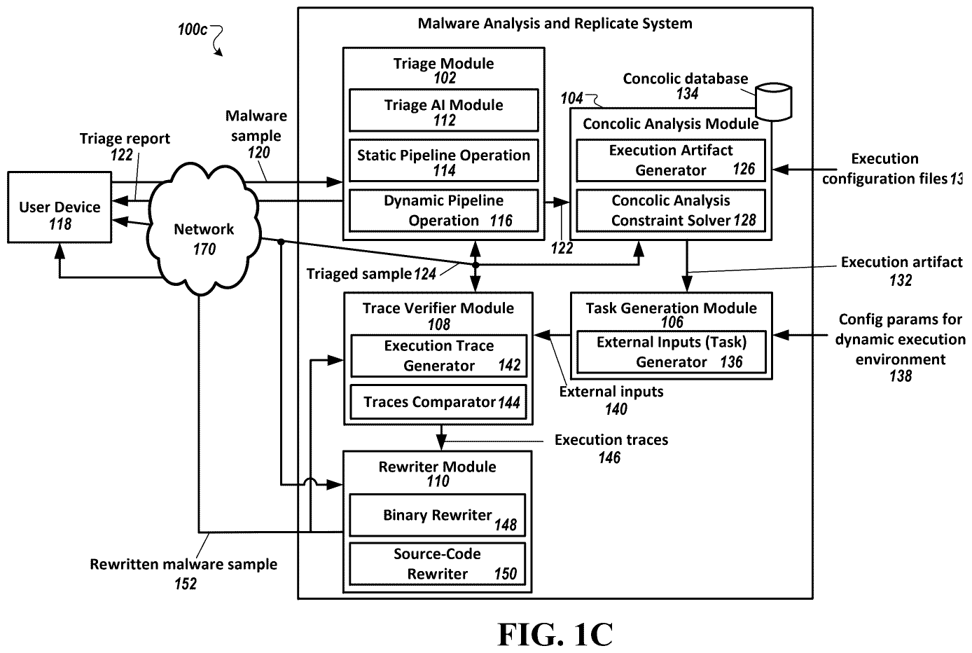

FIGS. 1A-1C each shows an example malware analysis and replication system 100 (shown as 100a, 100b, 100c) for (i) extracting malware behaviors through an analysis of real-world malware samples and (ii) replicating or modifying the malware behaviors depending on the malware analysis needs, in accordance with an illustrative embodiment. In FIG. 1A, the exemplary system 100a includes a triage module 102, a concolic analysis module 104, a task generation module 106, a trace verifier module 108, and a rewriter module 110. In FIG. 1B, the exemplary system 100b further includes a taxonomy module 160. In FIG. 1C, the exemplary system 100c is located in a dedicated, isolated cloud infrastructure configured to communicatively operate with a user device 118 via a network 170.

Triage Module (102). In the examples shown in FIGS. 1A-1C, the triage module includes a triage AI module 112, a static pipeline operation 114, and a dynamic pipeline operation 116. As shown, the triage module 102 is configured to receive, from the user device 118 directly (see FIGS. 1A-1B) or via the network 170 (see FIG. 1C), malware computer-readable instructions as a malware sample 120. The triage module 102 is then configured to determine, via the triage AI module 112, whether the malware sample 120 requires a concolic analysis (also referred to as a deep or advanced analysis). To determine whether the malware sample 120 requires the concolic analysis, the triage module 102 employs (i) the static pipeline operation 114 (also referred to as static pipeline mode) that includes a deterministic operation sequence, and (ii) the dynamic pipeline operation 116 (also referred to as agentic pipeline mode) that includes the same deterministic operation sequence augmented with the triage AI module 112. In some embodiments, the triage module does not employ an AI component.

In some embodiments, the AI modules are implemented using neural networks, machine learning (ML) models, or other artificial intelligence (AI) models. In some embodiments, the AI modules are implemented using LLM agents, AI agents, or ML agents. In some embodiments, the AI modules are encapsulated within the AI tools, ML tools, or software tools.

During execution of the deterministic operation sequence in the static pipeline operation 114, the triage module 102 is configured to (i) receive, via one or more preprocessing workers (also referred to as preprocessing threads or preprocesses), the malware sample 120, and (ii) modify, via the preprocessing workers, the malware sample 120 by unpacking it, disabling its binary base, removing its anti-analysis behaviors/layers, or reducing its loops. The triage module 102 is then configured to (i) determine, via one or more checking workers (also referred to as checking threads or checking processes), properties of the malware sample 120, and (ii) generate, via the checking workers, triage reports 122 of the malware sample modification and the determined properties. The triage module 102 is then configured to determine, via a rule-based engine, whether the concolic analysis should be initiated based on the modification and the determined properties.

In some embodiments, the triage module 102 is configured to transmit the triage reports 122 and the modified sample 124 (shown as triaged sample) to the user device 118 directly (see FIGS. 1A-1B) or via the network 170 (see FIG. 1C). In some embodiments, when the triage module 102 determines that the concolic analysis should be initiated, the triage module 102 is configured to transmit the triaged sample 124 to the concolic analysis module 104.

During execution of the deterministic operation sequence in the dynamic pipeline operation 116, the triage module 102 is further configured to receive, via the triage AI module 112, results of the modification of the sample 120 and the determined properties. When the received results of modification and the determined properties are insufficient to decide on the initiation of the concolic analysis, the triage module 102 is configured to determine, via the triage AI module 112, a request (e.g., JSON) for additional modification of the malware sample 120, additional determinations of the properties of the sample 120, or a reinitialization of the execution of the deterministic operation sequence. Otherwise, the triage module 102 is configured to initiate the concolic analysis by transmitting the triaged sample 124 to the concolic analysis module 104 without generating the request.

When the request is determined (e.g., more information or action needed), the triage module 102 is configured to re-execute the deterministic operation sequence, or a step thereof, based on the determined request. In some embodiments, the determine request follows predefined safety constraints and bounds (e.g., in a domain-expert playbook).

The operation steps of the triage module 102, including (i) receive the malware sample 120, (ii) preprocess the sample 120, (iii) tentatively determine whether the concolic analysis should be initiated (e.g., in static pipeline operation), (iv) request more information or action, if needed, to determine the initiation of the concolic analysis (e.g., in dynamic pipeline operation), and (v) finally decide on the initiation of the concolic analysis (e.g., in dynamic pipeline operation), may be coordinated by a finite-state machine (also referred to as an agentic orchestrator) with five states, each state corresponding to an operation step.

Concolic Analysis Module (104). In the examples shown in FIGS. 1A-1C, the concolic analysis module 104 includes an execution artifact generator 126 and a concolic analysis constraint solver 128. The concolic analysis module 104, operatively coupled to the triage module 102, is configured to (i) receive the triaged sample 124, and (ii) execute the concolic analysis in a unified execution environment to determine concolic analysis results that include a first set of malware behaviors represented through a set of execution artifacts 132. The concolic analysis module 104 is then configured to transmit the concolic analysis results to the task generation module 106.

During the execution of the concolic analysis, the concolic analysis module 104 is configured to receive (i) the triaged sample 124 and (ii) execution configuration files 130 to pre-configure the unified execution environment. The concolic analysis module 104 is then configured to (i) execute the triaged malware sample 124 in the unified execution environment and (ii) generate the set of execution artifacts 132 based on the execution of the triaged sample 124. The set of execution artifacts 132 may include a set of first execution traces and one or more execution symbolic variables with constraints.

In some embodiments, the concolic analysis module 104 is further configured to (i) receive, from the triage module 102, the triage report 122, and (ii) explore execution paths (also referred to as execution branches), guided by the information within the triage report 122, during execution in the unified execution environment. In some embodiments, the concolic analysis module 104 is configured to solve the constraints of the execution symbolic variables to determine concolic parameters of the concolic analysis, which can be subsequently stored in a concolic database 134.

In some embodiments, the concolic analysis module 104 is configured to (i) receive, directly from the user device 118 (e.g., skipping the triage module 102), the malware sample 120, (ii) execute the malware sample 120 in the unified execution environment, and (iii) generate the set of execution artifacts 132 based on the execution of the malware sample 120.

In some embodiments, the concolic analysis module 104 is configured to output (e.g., via an interface) the concolic analysis results and/or the resolved constraints to the user device 118. In some embodiments, the concolic analysis module 104 includes a concolic AI module (not shown) configured to (i) determine whether the concolic analysis needs the malware sample 120 or the triaged sample 124 and (ii) scale and automate the execution artifact generation 126 and the concolic constraint solvation 128 in the concolic analysis module 104.

Task Generation Module (106). In the examples shown in FIGS. 1A-1C, the task generation module 106 includes an external inputs generator 136. The task generation module 106, operatively coupled to the concolic analysis module 104, is configured to receive (i) the concolic analysis results that include the set of execution artifacts 132, which may include the first set of execution traces and one or more execution symbol variables, and (ii) one or more configuration parameters for a dynamic execution environment of the trace verifier module 108. The task generation module 106 is then configured to generate, via the external inputs generator 136, task files and/or network packets (e.g., network responses, files, registry entries) as one or more external inputs 140 using the received configuration parameters 138 and the set of execution artifacts 132, or the execution symbol variables therein. The task generation module 106 is then configured to transmit the external inputs 140 (e.g., task files, network packets) to the trace verifier module 108.

In some embodiments, the generated task files or network packets later configure (e.g., in the trace verifier module 108) a second set of malware behaviors represented by a second set of execution traces 146. In some embodiments, the task generation module 106 is configured to output (e.g., via an interface) the external inputs, including task files or network packets, to the user device.

In some embodiments, the task generation module 106 includes a task generation AI module (not shown) configured to scale and automate the external input generation 136 in the task generation module 106.

Trace Verifier Module (108). In the examples shown in FIGS. 1A-1C, the trace verifier module 108 includes an execution trace generator 142 and a traces comparator 144. The trace verifier module 108, operatively coupled to the task generator module 106, is configured to (i) receive the external inputs 140 (e.g., task files, network packets) and (ii) execute the triaged malware sample 124 (or 120 if the triage module 102 is skipped) in the dynamic execution environment to generate the second set of execution traces 146 using the triaged malware sample 124 (or 120 if the triage module 102 is skipped) and the external inputs 140. The trace verifier module 108 is then configured to compare, via the traces comparator 114, the second set of execution traces 146 to the first set of execution traces within the set of execution artifacts 132, to compare the second set of malware behaviors to the first set of malware behaviors to determine a set of verified behaviors for the malware sample 124.

The comparison between the second set of execution traces 146 and the first set of execution traces within the set of execution artifacts 132 (also referred to as the traces verification process) may include three levels: basic-block, API, and system-event. During the basic-block comparison/verification level, the trace verifier module 108 is configured to determine, via the traces comparator 144, a match between logic block sequences in the second set of execution traces 146 and logic block sequences in the first set of execution traces within the set of execution artifacts 132. During the API comparison/verification level, the trace verifier module 108 is configured to determine a match between function calls in the second set of execution traces 146 and function calls in the first set of execution traces within the set of execution artifacts 132. During the system-event comparison/verification level, the trace verifier module 108 is configured to determine a match between system events caused by the second set of execution traces 146 and system events caused by the first set of execution traces within the set of execution artifacts 132.

After the traces comparison/verification, the trace verifier module 108 is then configured to transmit, to the rewriter module 110, (i) the second set of execution traces 146 and (ii) an indicator (not shown) informing the rewriter module 110 of the comparison/verification result (e.g., match, mismatch) between the second set of execution traces 146 and the first set of execution traces within the set of execution artifacts 132. When there is a match at every comparison/verification level (e.g., basic-block, API, system-event), the trace verifier module 108 is configured to transmit, to the rewriter module 110, the second set of execution traces 146 and a “match” indicator (or the like), and the rewriter module 110 may be skipped. Otherwise, the trace verifier module 108 is configured to transmit, to the rewriter module 110, the second set of execution traces 146 and a “mismatch” indicator (or the like), and the rewriter module 110 may proceed.

In some embodiments, the trace verifier module 108 is configured to output (e.g., via an interface) the second set of execution traces 146 and execution results within the dynamic execution environment to the user device 118. In some embodiments, the trace verifier module 108 includes a trace verifier AI module (not shown) configured to scale and automate the execution trace generation 142 and the traces comparison/verification 144 in the trace verifier module 108. In some embodiments, the verifier AI module does not employ an AI component.

In some embodiments, the trace verifier module 108 is configured to receive, from the rewriter module 110, a rewritten malware sample 152 to (i) generate a third set of execution traces (not shown), (ii) compare the third set of execution traces and the first set of execution traces, and (iii) transmit, to the rewriter module 110, the third set of execution traces and an indicator informing a match or mismatch between the third and first sets of execution traces.

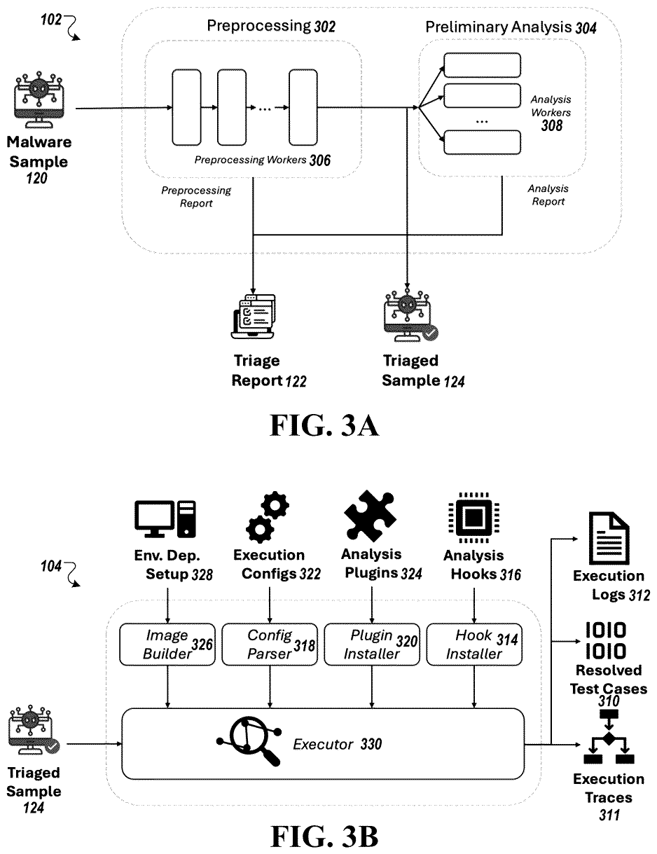

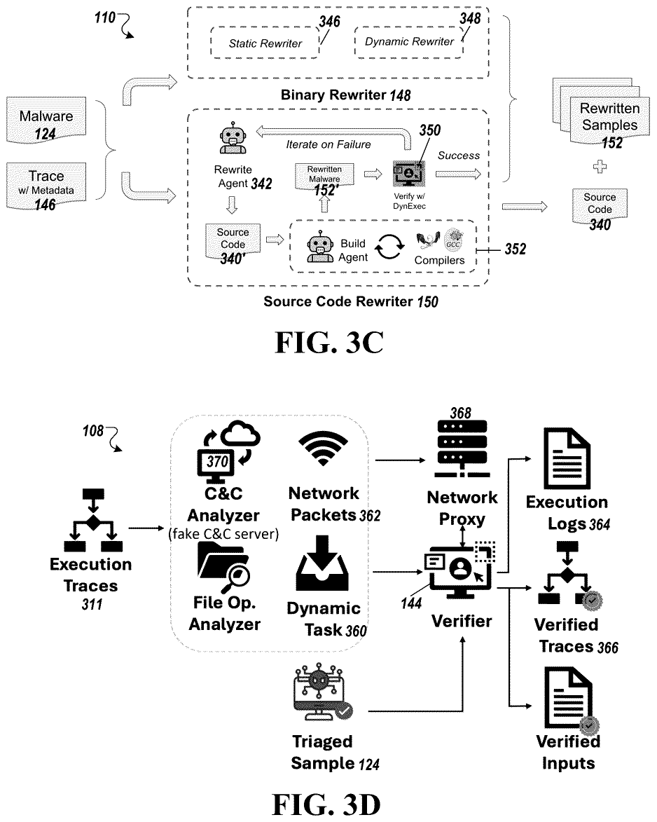

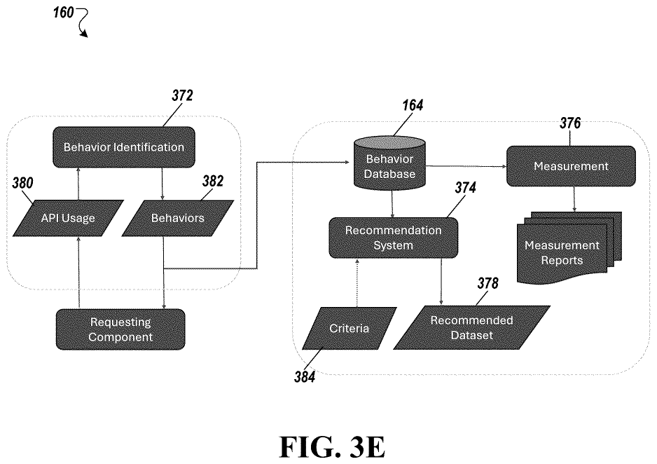

Rewriter Module (110). In the examples shown in FIGS. 1A-1C, the rewriter module 110 includes a binary rewriter 148 and a source-code rewriter 150. The rewriter module 110, operatively coupled to the triage module 102 and the trace verifier module 108, is configured to receive the second set of execution traces 146 (e.g., with behavior metadata) and the triaged malware sample 124. The rewriter module 110 is then configured to run the binary rewriter 148 and the source-code rewriter 150 in parallel to generate (i) rewritten samples 152, and (ii) corresponding source code (e.g., 340, FIG. 3C) and build instructions when applicable (e.g., when the source-code rewriter 150 succeeds). The rewritten sample 152 may include only verified behaviors generated in the trace verifier module 108, adding an extra layer of safety assurance. Specifically, when executed with the generated external inputs 140, the rewritten sample 152 may exhibit the same behaviors as the triaged malware 124. When the rewritten sample 152 is generated by the binary rewriter 148, the rewritten sample 152 may contain only instructions executed during the dynamic execution in the trace verifier module 108 (e.g., unseen instructions are rewritten to trigger exceptions). When the rewritten sample 152 is generated by the source-code rewriter 150, the rewritten sample 152 may be built from the source code that contains only behaviors seen during the analysis stage (e.g., 104). The final output 152 is the rewritten malware sample for subsequent studies on malware behaviors and/or generation of behavioral signatures for the detection of the malware and its variants.

During the rewriting of the malware sample 124 (or 120 if the triage module is skipped), the binary rewriter 148 is configured to (i) disassemble the malware sample 124 (or 120) to locate executable instructions therein, (ii) determine executed instructions within the executable instructions based on the second set of execution traces 146, and (iii) modify the executable instructions by rewriting unexecuted instructions from the executable instructions with exception-triggering instructions, where execution of the executable instructions in the malware sample 124 (or 120) may terminate when reaching the exception-triggering instructions. The source code rewriter is then configured to (i) prompt a rewriter AI module (e.g., 342, FIG. 3C) with one or more implementation constraints to generate source code, (ii) compile generated source code to generate the rewritten malware sample 152, (iii) execute the rewritten malware sample 152 to obtain a newly generated set of execution traces that represent a set of behaviors of the rewritten malware sample 152, (iv) iteratively rewrite the generated source code until the set of behaviors of the rewritten malware sample 152 matches the verified behavior, and (v) output the rewritten malware sample 152 to the user device 118 and/or the trace verifier module 108.

In some embodiments, the rewriter module 110 is configured to transmit the rewritten malware sample 152 to the trace verifier module 108 to generate the third set of execution traces for further comparison with the first set of execution traces (e.g., within the set of execution artifacts 132), as discussed above.

Taxonomy Module (160). In the example shown in FIG. 1B, the taxonomy module 160 includes a malware sample categorization process and a behavior database 164. Taxonomy module 160, operatively coupled to the rewriter module 110, is configured to receive the rewritten malware sample 152 and categorize the rewritten malware sample 152 based on the complexity of the second set of malware behaviors. The taxonomy module 160 is then configured to store the categorized malware samples in the behavior database 164.

In some embodiments, the taxonomy module 160 is configured to receive (e.g., from other modules) and categorize the triaged malware sample 124 based on the complexity of a set of malware behaviors associated with it. In some embodiments, the taxonomy module 160 is configured to output (e.g., via an interface) the categorized malware samples stored in the behavior database 164 to the user device 118. In some embodiments, the taxonomy module 160 includes a taxonomy AI module (not shown) to scale and automate the malware sample categorization 162 in the taxonomy module 160.

### Example Method

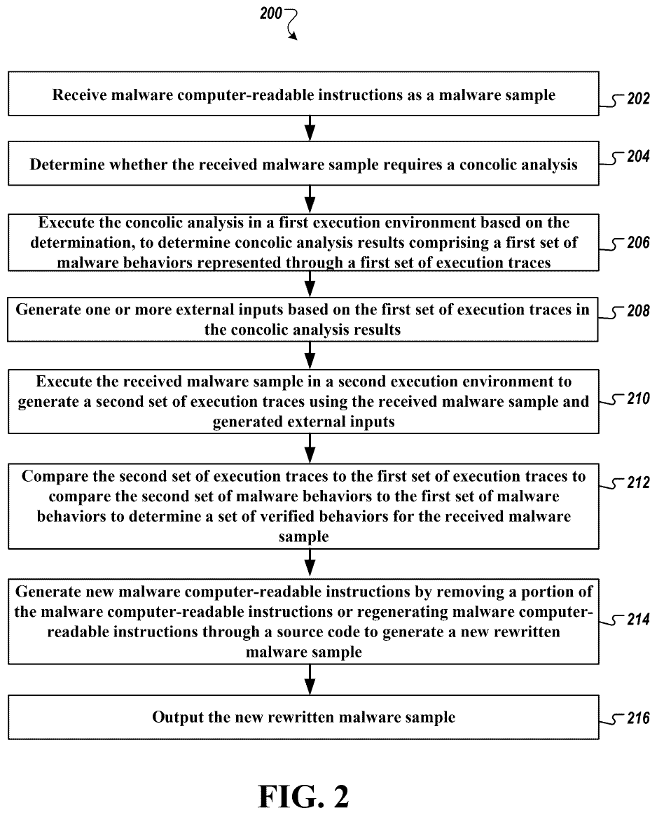

FIG. 2 shows an example operation method 200 for a pipeline operation of the exemplary system to (i) extract malware behaviors through an analysis of real-world malware samples and (ii) utilize confirmed execution traces and required external inputs to replicate the traces accurately, in accordance with an illustrative embodiment.

The method 200 includes receiving (202) malware computer-readable instructions as a malware sample (e.g., 120, FIGS. 1A-1C). The method 200 includes determining (204), via the one or more AI modules (e.g., the triage AI module 112 at the triage module 102, FIGS. 1A-1C), whether the malware sample (e.g., 120, FIGS. 1A-1C) requires a concolic analysis. The method 200 includes executing (206) (e.g., at a concolic analysis module 104, FIGS. 1A-1C) the concolic analysis in a first execution environment (e.g., unified execution environment) based on the determination, to determine concolic analysis results comprising a first set of malware behaviors represented through a first set of execution traces (e.g., within the set of execution artifacts 132, FIGS. 1A-1C) (e.g., API sequences).

The method 200 includes generating (208) (e.g., at a task generator module 106, FIGS. 1A-1C) one or more external inputs (e.g., 140, FIGS. 1A-1C) (e.g., network responses, files, registry entries) based on the first set of execution traces (e.g., within the set of execution artifacts 132, FIGS. 1A-1C) in the concolic analysis results. The method 200 includes executing (210) (e.g., at a verifier module 108, FIGS. 1A-1C) the received malware sample (e.g., 120, 124, FIGS. 1A-1C) in a second execution environment (e.g., dynamic execution environment) to generate a second set of execution traces (e.g., 146, FIGS. 1A-1C) using the received malware sample (e.g., 120, 124, FIGS. 1A-1C) and generated external inputs (e.g., 140, FIGS. 1A-1C). The method 200 includes comparing (212) (e.g., at the verifier module 108, FIGS. 1A-1C) the second set of execution traces (e.g., 146, FIGS. 1A-1C) to the first set of execution traces (e.g., within the set of execution artifacts 132, FIGS. 1A-1C), to determine a set of verified behaviors for the received malware sample (e.g., 120, 124, FIGS. 1A-1C).

The method 200 includes generating (214) new malware computer-readable instructions by removing a portion of the malware computer-readable instructions or regenerating malware computer-readable instructions through a source code (e.g., 340, FIG. 3C) to generate a new rewritten malware sample (e.g., 152, FIGS. 1A-1C), wherein the new rewritten malware sample (e.g., 152, FIGS. 1A-1C) is modified and compared in an iterative manner until a set of behaviors of the new rewritten malware sample (e.g., 152, FIGS. 1A-1C) matches the verified behavior via comparison of newly generated second sets of execution traces (e.g., 146, FIGS. 1A-1C) to the first set of execution traces (e.g., 132, FIGS. 1A-1C). The method 200 includes outputting (216) the new rewritten malware sample (e.g., 152, FIGS. 1A-1C, where the output is subsequently employed for studies on malware behaviors and/or generation of behavioral signatures for a detection of the malware and its variants.

The determination (204) whether the malware sample (e.g., 120, FIGS. 1A-1C) requires concolic analysis can include instructions to execute a triage operation having (i) a static pipeline operation (e.g., 114, FIGS. 1A-1C) and (ii) an agentic pipeline operation (e.g., 116, FIGS. 1A-1C), where the static pipeline operation (e.g., 114, FIGS. 1A-1C) includes a deterministic operation sequence, and wherein the agentic pipeline operation (e.g., 116, FIGS. 1A-1C) includes the deterministic operation sequence augmented with a large-language-model (LLM) agent (e.g., 112, FIGS. 1A-1C).

In some embodiments, during the static pipeline operation (e.g., 114, FIGS. 1A-1C), the execution of the deterministic operation sequence includes (i) receiving, via one or more processes (e.g., preprocessing workers), the malware sample (e.g., 120, FIGS. 1A-1C), (ii) modifying, via the one or more processes (e.g., preprocessing workers), the malware sample (e.g., 120, FIGS. 1A-1C), where the modification includes unpacking, disabling binary base (e.g., dynamic base), removing anti-analysis behaviors, or reducing loops, (iii) determining, via the one or more processes (e.g., checking workers), properties of the malware sample (e.g., 120, FIGS. 1A-1C), and (iv) determining, via a rule-based engine, an initiation of the execution of the concolic analysis based on the modification and the determined properties.

In some embodiments, during the agentic pipeline operation (e.g., 116, FIGS. 1A-1C), the execution of the deterministic operation sequence further includes (i) receiving, via the one or more AI modules (e.g., 112, FIGS. 1A-1C), results of the modification and the determined properties, (ii) determining, via the one or more AI modules (e.g., 112, FIGS. 1A-1C), a request (e.g., JSON) for additional modifications of the malware sample, additional determinations of the properties of the malware sample, or a reinitialization of the execution of the deterministic operation sequence, where the determined request follows predefined safety constraints and bounds (e.g., in a domain-expert playbook), and (iii) executing the deterministic operation sequence, or a step thereof, based on the determined request.

The execution (206) of the concolic analysis can include (i) receiving (e.g., at the concolic analysis module 104, FIGS. 1A-1C) configuration files to configure the first environment, (ii) executing (e.g., at the concolic analysis module 104, FIGS. 1A-1C) the malware sample (e.g., 120, 124, FIGS. 1A-1C) in the first environment, (iii) generating (e.g., at the concolic analysis module 104, FIGS. 1A-1C) the first set of execution traces (e.g., within the set of execution artifacts 132, FIGS. 1A-1C) based on the execution of the malware sample (e.g., 120, 124, FIGS. 1A-1C), wherein the first set of execution traces (e.g., within the set of execution artifacts 132, FIGS. 1A-1C) includes one or more execution symbolic variables with constraints, and (iv) solving the constraints to find a solution (e.g., concolic parameters satisfying the constraints for each explored execution path) to a failure (if any) (e.g., meeting constraints when exploring a failure execution path, during the concolic execution) of the concolic analysis, where the solution is subsequently stored in a concolic database (e.g., 134, FIGS. 1A-1C).

The generation (208) of the one or more external inputs (e.g., at the task generation module 106, FIGS. 1A-1C) can include (i) receiving (e.g., at the task generator module 106, FIGS. 1A-1C) the first set of execution traces (e.g., within the set of execution artifacts 132, FIGS. 1A-1C), and the one or more execution symbol variables therein, from the concolic analysis results, (ii) receiving (e.g., at the task generator module 106, FIGS. 1A-1C) one or more configuration parameters of the second execution environment, and (iii) generating (e.g., at the task generator module 106, FIGS. 1A-1C) task files or network packets as the one or more external inputs (e.g., 140, FIGS. 1A-1C), using the received one or more configuration parameters and the received first set of execution traces (e.g., within the set of execution artifacts 132, FIGS. 1A-1C), or the execution symbol variables therein, wherein the generated task files or network packets configure the second set of malware behaviors represented by the second set of execution traces (e.g., 146, FIGS. 1A-1C).

The comparison (212) of the second set of execution traces (e.g., 146, FIGS. 1A-1C) (e.g., at the verifier module 108, FIGS. 1A-1C) to the first set of execution traces (e.g., within the set of execution artifacts 132, FIGS. 1A-1C) include (i) determining (e.g., at the verifier module 108, FIGS. 1A-1C) a match between logic block sequences in the second set of execution traces (e.g., 146, FIGS. 1A-1C) and logic block sequences in the first set of execution traces (e.g., within the set of execution artifacts 132, FIGS. 1A-1C), (ii) determining (e.g., at the verifier module 108, FIGS. 1A-1C) a match between function calls in the second set of execution traces (e.g., 146, FIGS. 1A-1C) and function calls in the first set of execution traces (e.g., within the set of execution artifacts 132, FIGS. 1A-1C), and (iii) determining (e.g., at the verifier module 108, FIGS. 1A-1C), a match between system events caused by the second set of execution traces (e.g., 146, FIGS. 1A-1C) and system events caused by the first set of execution traces (e.g., within the set of execution artifacts 132, FIGS. 1A-1C).

The generation (214) of the new rewritten malware sample (e.g., 152, FIGS. 1A-1C) (e.g., by a rewriter module 110, FIGS. 1A-1C) can include disassembling, via a binary rewriter (e.g., 148, FIGS. 1A-1C), the malware sample to locate executable instructions therein, (ii) determining, via the binary rewriter (e.g., 148, FIGS. 1A-1C), executed instructions within the executable instructions based on the second set of execution traces (e.g., 146, FIGS. 1A-1C), (iii) modifying, via the binary rewriter (e.g., 148, FIGS. 1A-1C), the executable instructions by rewriting unexecuted instructions from the executable instructions with exception-triggering instructions, where execution of the executable instructions in the malware sample (e.g., 120, 124, FIGS. 1A-1C) terminates when reaching the exception-triggering instructions, (iv) prompting, via a source-code rewriter (e.g., 150, FIGS. 1A-1C), one or more AI modules (e.g., a rewriter AI module 342, FIG. 3C) with one or more implementation constraints to generate source code (e.g., 340, FIG. 3C), (v) compiling, via the source-code rewriter (e.g., 150, FIGS. 1A-1C), generated source code (e.g., 340, FIG. 3C) to generate the new rewritten malware sample (e.g., 152, FIGS. 1A-1C), (vi) executing, via the source-code rewriter (e.g., 150, FIGS. 1A-1C), the new rewritten malware sample (e.g., 152, FIGS. 1A-1C) to obtain the newly generated second set of execution traces that represent the set of behaviors of the new rewritten malware sample (e.g., 152, FIGS. 1A-1C), (vii) iteratively rewriting, via the source-code rewriter (e.g., 150, FIGS. 1A-1C), the generated source code (e.g., 340, FIG. 3C) until the set of behaviors of the new rewritten malware sample (e.g., 152, FIGS. 1A-1C) matches the verified behavior, and (viii) outputting the new rewritten malware sample (e.g., 152, FIGS. 1A-1C), where the new rewritten malware sample (e.g., 152, FIGS. 1A-1C) is constrained to exhibit only the verified behavior.

In some embodiments, the method 200 further includes categorizing (e.g., at a taxonomy module 160, FIG. 1B) the adjusted malware sample (e.g., 152, FIGS. 1A-1C) based on the complexity of the second set of malware behaviors.

### Example Triage Module

FIG. 3A shows an example triage module 102 of the exemplary system, in accordance with an illustrative embodiment. The triage module 102 is configured to perform an initial analysis and normalization of each malware sample 120 and determine whether the samples 120 should advance to more computationally expensive stages of a pipeline operation of the exemplary system. In some embodiments, the triage module includes two stages (e.g., a preprocessing stage, a checking stage) and an orchestrator (also referred to as an orchestration layer). In the preprocessing stage, preprocessing workers may transform the input malware samples (e.g., unpacking, removing anti-analysis logic, and reducing loops). In the checking stage, the checking workers may characterize the preprocessed samples. The orchestrator (e.g., agentic orchestrator) may coordinate workers, combine results, and produce a triage decision.

Inputs and Outputs. The input to the triage module 102 may include target malware samples (also referred to as artifacts) to be preprocessed, including executable and any malware-specific auxiliary artifacts (e.g., custom DLLs or resource files) required for normal execution. The output of the triage module 102 may include (i) preprocessed malware samples 124 (e.g., unpacked binaries, binaries with anti-analysis logic neutralized or loops reduced), (ii) preprocessing reports and checking reports 122, and (iii) a triage decision record (not shown) that captures both the deterministic rules applied and any large language model agentic reasoning used (e.g., expressed in a machine-readable format for subsequent modules).

Operation Flow. In FIG. 3A, the operation flow of the triage module 102 includes two stages: a preprocessing stage 302 and a checking stage 304 (shown as a preliminary analysis stage). The preprocessing stage 302 precedes the checking stage 304, and each stage employs multiple workers (e.g., preprocessing workers 306, analysis/checking workers 308) assigned to specific tasks that support the triage pipeline operation. The preprocessing stage 302 is configured to modify malware samples 120 (also referred to as an artifact) into triaged samples 124 to prepare them for subsequent intensive analysis. The checking stage 304 is configured to examine various properties of the malware samples 124 and generate reports 122 that inform subsequent modules, enabling them to adopt a corresponding analysis strategy.

In the preprocessing stage 302, each preprocessing worker 306 is configured to receive the input malware samples, perform specific preprocessing tasks (e.g., unpacking, anti-analysis removal, loop reduction) (also referred to as preprocessing transformations), and generate output samples (shown as triaged samples) while producing reports 122 along the way. The preprocessing workers 306 are arranged sequentially, with one preprocessing worker's output serving as the input to the next. The initial input malware samples 120 fed to the triage module 102 may enter the first preprocessing worker, while the output 124 from the last preprocessing worker may become the input for the checking stage 304. Each preprocessing worker 306 may modify their input samples as necessary; however, no modifications are made to the original files (e.g., malware samples 120) on the file system. Instead, preprocessing workers 306 may apply changes in memory, saving any modifications as new output samples. For example, if a preprocessing worker's task is to disable the dynamic base of a malware binary, the worker should only proceed when the dynamic base is currently enabled. If the dynamic base is already disabled, the preprocessing worker can create file copies, producing output samples identical to the input. This approach ensures the original input binary (e.g., sample 120) remains unchanged, with any modifications applied only to the output samples.

The order of preprocessing workers 306 in the preprocessing stage 302 may be predefined, e.g., in a sequence of unpacking, dynamic base disabling, anti-analysis removal, and loop reduction. For example, an unpacking worker should precede any checker responsible for identifying or removing anti-analysis behaviors; otherwise, the checker may fail to analyze a packed binary effectively. During preprocessing, each preprocessing worker 306 may be configured to generate a report 122 that includes debugging messages (e.g., errors, warnings, logs) and additional information gathered while processing the samples. For example, an unpacking worker's report may include details on whether the malware sample appears packed and whether unpacking succeeded. All reports from the preprocessing workers 306 may be aggregated into a single report representing the preprocessing stage's output (e.g., 124).

In the checking stage 304, each checking worker 308 (e.g., obfuscation checker, runtime environment checker, additional property checker) may independently process the same set of input samples (e.g., the output samples 124 from the preprocessing stage 302) without altering them. Each checking worker 308 is configured to perform specific checks (e.g., obfuscation check, runtime environment check, additional property check) and generate a report on the malware's properties. The individual reports may then be aggregated into a final report for the checking stage 304. Different from the preprocessing 302, the sequence in which the checking workers operate in the checking stage 304 does not affect the results or effectiveness.

Upon completion of the preprocessing stage 302 and the checking stage 304, the triage module 102 is configured to output the preprocessed samples 124 from the preprocessing stage 302 and reports 122 from both the preprocessing stage 302 and the checking stage 304.

Pipeline Operation Modes. The triage module 102 may operate in two complementary modes: a static pipeline mode (e.g., 114, FIGS. 1A-1C) and an agentic pipeline mode (e.g., 116, FIGS. 1A-1C). The static pipeline mode (e.g., 114, FIGS. 1A-1C) implements a deterministic, rule-based operation flow of preprocessing and checking steps described in FIG. 3A. The agentic pipeline mode (e.g., 116, FIGS. 1A-1C) implements the same deterministic operation flow augmented with a constrained large-language-model (LLM) agent (also referred to as triage reasoner agent) that can request additional evidence or optional analyses when necessary, but only within strict, expert-defined bounds (e.g., domain-expert playbooks).

In the static pipeline line (e.g., 114, FIGS. 1A-1C), a rule-based engine is employed to facilitate the deterministic, rule-based operation flow of preprocessing and checking steps. In some embodiments, the rule-based engine is configured to determine whether the malware samples 120 should proceed to concolic analysis based on a set of predefined rules, such as (i) drop the samples if unpacking fails and entropy is larger than a predefined threshold, (ii) skip concolic analysis if the target operation system (OS) is obsolete, (iii) promote to concolic analysis if anti-analysis patterns are removed and loop counts are reduced, etc.

In the agentic pipeline mode (e.g., 116, FIGS. 1A-1C), the triage module 102 is configured to further evaluate, via an agentic orchestrator (e.g., a finite-state machine, e.g., sample→preprocess→tentative check→additional evidence?→final check→decide), whether cleared predicates for each of the preprocessing and checking stages are satisfied (e.g., is the sample unpacked? Is the anti-analysis behavior of the sample removed? Is the runtime environment determined?, etc.). If evidence for the satisfaction of the cleared predicates is insufficient or contradictory, the triage module 102 is then configured to send, via the agent orchestrator a prompt to a triage agent (e.g., an LLM 112, FIGS. 1A-1C) (also referred to as triage reasoner agent) to request a response or suggestion. In some embodiments, the prompt is configured to include file metadata (e.g., hash, headers, entropy, import tables), results from the preprocessing stage 302 (e.g., unpacking, anti-analysis removal, loop reduction), checking reports 122 (e.g., obfuscation, environment), rules from a playbook, and a list of allowed actions. In some embodiments, the response or suggestion from the triage agent is a JSON object, e.g., as shown in Table 1.

```
TABLE 1
{
  “action”: “run_secondary_unpacking_worker”,
  “reason”: “.text entropy=7.8, inconsistent with unpacking validator's
  output”
}
```

In Table 1, the agentic orchestrator maps the action request “run_secondary unpacking_worker” to a deterministic tool invocation defined in a playbook. Invalid requests may be ignored or overrideen by rules in the playbook. The action suggested by the triage agent (e.g., 112, FIGS. 1A-1C) should be defined as one of the allowed actions in a playbook (e.g., domain-expert playbook). The playbook is configured to (i) define allowed actions (e.g., request a dynamic trace, run an entropy profiler) for each stage of the triage module 102, (ii) express domain heuristics (e.g., “never trust unpacking result if anti-analysis logic is still present”), (iii) enforce cost and safety constraints (e.g., heavy dynamic tracing may run if two cheaper checks disagree, and (iv) override LLM suggestions when inconsistent with safety or efficiency requirements.

Table 2 shows example agentic behaviors of the triage agent (e.g., 112, FIGS. 1A-1C) used to program/configure the triage module 102.

TABLE 2

| Example | Details |
|---|---|
| 1) Ambiguous | Reason/Scenario: Unpacking worker says: “likely not packed.” Unpacking |
| packing | validator says: “Entropy is high (7.8). Unpacking validator confidence is low |
| | (0.41). Malware 120 imports only 3 functions, unusually sparse”. |
| | Agentic action: Triage agent (e.g., 112, FIGS. 1A-1C) runs a different |
| | unpacking worker and updates evidence (e.g., “action”: |
| | “run_secondary_unpacking_worker”). |
| | Outcome: If both unpacking workers disagree, the fallback rule triggers a |
| | small dynamic trace. If unpacking is still ambiguous, the triage agent (e.g., |
| | 112, FIGS. 1A-1C) marks the malware sample 120 as “packed/unsupported” |
| | and skips advanced analysis. |
| 2) Anti-analysis | Reason/Scenario: Anti-bypass worker (e.g., 306) removes several VM- |
| removal | detection stubs. Dynamic base disabling succeeded. Loop reducer (e.g., 306) |
| | reduces a 1200-iteration loop to 3. Obfuscation checking worker (e.g., 308) |
| | finds obfuscated control-flow flattening. |
| | Agent action: Triage agent (e.g., 112, FIGS. 1A-1C) verifies whether the |
| | rewritten file still exhibits expected system calls (e.g., “action”: |
| | “request_light_dynamic_sandbox_run”). |
| | Outcome: if dynamic trace shows expected API patterns, triage agent (e.g., |
| | 112, FIGS. 1A-1C) promotes the dynamic trace to full symbolic-execution |
| | path; otherwise, triage agent (e.g., 112, FIGS. 1A-1C) flags it for deeper |
| | preprocessing. |
| 3) Unknown runtime | Reason/Scenario: Imports suggest .NET, but the malware sample 120 also |
| requirements | contains native PE sections. The runtime checker (e.g., 308) is uncertain |
| | whether the program expects a GUI. Static control flow graph (CFG) suggests |
| | the presence of a WinForms event loop, but no manifest is present. |
| | Agent action: “action”: “run_runtime_api_import_profiler”. |
| | Outcome: If the API profiler shows Win32 API calls for GUI setup, the triage |
| | agent (e.g., 112, FIGS. 1A-1C) marks the malware sample 120 as GUI- |
| | dependent. The downstream dynamic analysis environment is configured |
| | accordingly. |
| 4) Loop-reduction | Reason/Scenario: The loop reducer (e.g., 306) reduces an infinite loop. |
| validity check | Worker reports “modified loop count from infinite → 3.” |
| | Agent action: the triage agent (e.g., 112, FIGS. 1A-1C) suggests a quick |
| | sandbox run to ensure execution follows a normal path (e.g., “action”: |
| | “run_validation_trace”). |
| | Outcome: If behavior is preserved, the advanced analysis pipeline (e.g., 104, |
| | FIGS. 1A-1C) proceeds. If execution fails or stalls, the triage agent (e.g., 112, |
| | FIGS. 1A-1C) marks the malware sample 120 as “requires manual |
| | preprocessing.” |

Preprocessing Workers. The preprocessing stage 302 contains preprocessing workers 306 that preprocess the malware samples 120 (also referred to as malware artifacts) and generate new samples when needed. Preprocessed malware samples 124 may be easier for subsequent modules in the exemplary system to analyze than the initial malware samples 120. Table 3 shows the details of each of the preprocessing workers 306 in the preprocessing stage 302.

TABLE 3

| Worker type | Task |
|---|---|
| Unpacking worker | The unpacking worker may unpack target malware 120 using an unpacking |
| | component. |
| | Unpacking component. The unpacking component may employ an emulation- |
| | based unpacking process that emulates the execution of the malware binary |
| | from its entry point. During this emulation, the unpacking worker may monitor |
| | the execution state for patterns indicating that the unpacking process has |
| | completed. In other words, the unpacking component may first determine |
| | whether the malware 120 is packed or not by observing the unpacking |
| | behaviors during malware execution. Such patterns may include the execution |
| | sequence aligning with known byte sequences of packers, execution flow |
| | transitioning between sections, and execution flow transitioning to regions |
| | previously modified by the process itself. Once these patterns are identified, |
| | the emulation may stop. The unpacking worker may then dump the process |
| | memory and adjust offsets in the import tables, relocations, and section |
| | headers to produce an executable and unpacked binary. The goal of the process |
| | is to unpack, e.g., to recover the original instructions ready for execution at |
| | runtime, free from compression and encryption. This can be beneficial for |
| | subsequent static analysis tools, which may require an unobstructed view of |
| | the malware binary - something not possible with packed binaries, where the |
| | actual code remains hidden. |
| | Furthermore, state-of-the-art external unpackers may be integrated to assist in |
| | the unpacking task. A challenge may be accommodating the varying runtime |
| | requirements of different unpackers. For instance, tools such as PEID and |
| | ExeInfoPE may require a Windows operating system, whereas others, such as |
| | unipacker and UPX (-d), may not. To address this, the unpacking worker may |
| | maintain virtual machines with the appropriate environment (e.g., OS, runtime |
| | libraries) preconfigured for the external unpackers. A virtual machine agent |
| | may also develop that runs inside these virtual machines, facilitating |
| | communication with the unpacking worker on the host system for tasks such as |
| | file transfer, state monitoring, and dispatching runtime commands. Once the |
| | external unpackers complete processing the malware binary, the virtual |
| | machine agent transports the unpacked binary back to the host system. All |
| | external unpackers may be executed simultaneously on the initially detected |
| | packed malware binary and collect the outcomes from those that successfully |
| | create an unpacked sample. |
| | Finally, the worker may generate a report detailing all logs produced during |
| | packer detection, emulation-based unpacking, and external tools. |
| | Subsequently, the worker may run all the unpacked samples obtained from |
| | both emulation-based and external unpacking methods. During this phase, any |
| | unpacked crash samples are filtered out and deemed invalid. If multiple |
| | samples remain after filtering, one may be chosen randomly to be included as |
| | the unpacked sample in the output samples. |
| Dynamic base | When a program is executed by the operating system, the executable loader |
| disabling worker | may assign the program to a specific virtual address in the memory space, |
| | known as the image base of the process. However, many programs, including |
| | malware samples, can have a dynamically changing image base address. |
| | Although a dynamic image base does not impact the execution of the malware |
| | binary, it can complicate the analysis of the binary, making it more tedious and |
| | less efficient. For instance, static analysis tools may generate information |
| | assuming static virtual addresses. To utilize this information, dynamic analysis |
| | tools may perform additional calculations, such as using relative addresses, to |
| | map the dynamically adjusted virtual address to the one assumed by static |
| | analysis tools. Furthermore, when integrating results from both static and |
| | dynamic analysis tools, a similar reconciliation of addressing may be required, |
| | adding another layer of complexity to the analysis process. |
| | Given these reasons, ensuring that a program loads at the same virtual address |
| | each time is advantageous for the entire analysis pipeline. The dynamic base- |
| | disabling worker facilitates this by modifying the IMAGE_DLL_{—} |
| | CHARACTERISTICS_DYNAMIC_BASE bit in the DLL Characteristics field |
| | of the PE binary's optional header. Specifically, if this bit is detected to be set |
| | to 1, it is changed to 0. |
| | Finally, the dynamic base disabling worker may generate a report indicating |
| | whether the original binary had the dynamic base enabled and whether the |
| | modification was completed. If the modification is successful, the modified |
| | binary may be provided as an output sample, along with the report. |
| Anti-bypass worker | Many malware samples can attempt to evade detection by analysis tools by |
| | concealing their malicious behavior when they detect an analysis environment. |
| | Such actions, where the malware senses and reacts to an analysis environment, |
| | are known as anti-analysis behaviors. Anti-analysis behaviors may pose |
| | challenges for malware analysis for two reasons. First, they can bypass some |
| | dynamic analysis tasks, such as dynamic execution and concolic analysis, |
| | performed in the pipeline's later stages. Second, although several dynamic |
| | analysis techniques can skip these anti-analysis behaviors, they still require |
| | additional time to explore alternative execution paths, resulting in |
| | inefficiencies. Consequently, it is advantageous to remove anti-analysis |
| | behaviors early, which is the anti-bypass worker's primary objective. |
| | The anti-bypass worker may identify and remove known anti-analysis patterns |
| | within the binary through static binary rewriting, which may involve two steps: |
| | (i) the pattern-matching step and (ii) the static rewriting step. |
| | (i) Pattern matching. In this step, the worker may search the malware |
| | binary for known byte sequence patterns associated with anti-analysis |
| | behaviors. To ensure scalability, the worker uses YARA, an open-source |
| | multi-platform tool that may identify binary patterns in malware samples. |
| | Open-source YARA rules available online may be collected, and custom |
| | YARA rules for the worker may be created as needed to address new malware |
| | families. Input to the pattern-matching process may include both community- |
| | generated YARA rules and custom in-house YARA rules. This process outputs |
| | a list of binary offsets where matches are found for each YARA rule. |
| | (ii) Static rewriting. In this step, the goal is to remove the anti-analysis |
| | behaviors identified during the pattern-matching step. A domain-specific |
| | language (DSL) is developed that allows users to define “actions” detailing |
| | how to rewrite these behaviors. Different patterns can be addressed with |
| | different actions, and some actions accept arguments to specify further |
| | modification details. Additionally, the DSL design is compatible with the DSL |
| | from CAPEv2, which may facilitate adoption of the latest rules available in |
| | community resources. The supported actions, which may be expanded over |
| | time, include (a) Jmp, (b) Skip, and (c) Ret. The action Jmp may replace the |
| | instruction at the target address with an unconditional branching instruction. |
| | The action Jmp may take an “offset” argument. Without the offset, the target |
| | instruction should be a conditional branch. With an offset, the target |
| | instruction jumps to ‘[target address]+offset’. The action Jmp may bypass the |
| | anti-analysis logic when it is within one branch of a conditional instruction. |
| | The action Skip may replace the instruction at the target address with no- |
| | operation (NOP) instructions. The action Skip may remove the anti-analysis |
| | logic by replacing it with no-operation instructions. The action Ret may |
| | replace the instruction at the target address with a RET instruction. The action |
| | Ret can take an “offset” argument, specifying the number of stack elements |
| | (words) to pop. The default offset is 1, popping only the return address. An |
| | offset changes the instruction to ‘RET {(offset-1)*sizeof(size_t)} . For |
| | example, ‘offset=2’ results in ‘RET 4’ for an x86 binary. The action Skip may |
| | skip the execution of the remainder of a function by returning directly to the |
| | caller function. |
| | The DSL syntax may link identified pattern offsets with specific actions. For |
| | example, using a syntax such as ‘addr=$pattern1,action=jmp’, the action “jmp” |
| | may be designated to be taken for the particular pattern “pattern1” identified |
| | during the pattern matching step. Additionally, the action can be based on an |
| | offset from the identified pattern, utilizing the syntax |
| | ‘addr=$pattern1+<offset>,action=jmp’. This flexibility allows precise |
| | targeting of instructions for modification, ensuring the anti-analysis behavior is |
| | located and neutralized. |
| | After completing the modifications, the anti-bypass worker may return a |
| | binary with all identified anti-analysis behaviors skipped/removed. The worker |
| | may then execute the rewritten sample to verify that the malware functions |
| | correctly and does not crash. Finally, a report may be generated detailing the |
| | identified anti-analysis behaviors, their offsets in the malware sample, the |
| | success of the rewriting process in removing these behaviors, and whether the |
| | rewritten sample executes without issues. |
| Loop reducer | Loops in programs introduce states and can create efficiency challenges for |
| | many analysis techniques, such as symbolic analysis and concolic execution. |
| | The loop reducer worker focuses on detecting and reducing loops that repeat |
| | the same logic, a behavior commonly seen in malware. For instance, malware |
| | may use loops to duplicate itself hundreds of times on a disk or to send a |
| | multitude of requests to a web server. While the downstream pipeline contains |
| | mechanisms to handle such behaviors, they can hinder the analysis process and |
| | impede scaling to real-world samples. Loop reducer uses data-flow analysis |
| | and pattern matching to identify known naive loops, enabling it to detect naive |
| | loop behaviors by analyzing the flow of data within the program and |
| | pinpointing loops that repeatedly execute the same logic. Once identified, |
| | these loops can be modified to reduce their iteration count, improving the |
| | efficiency of subsequent analysis tasks. |
| | The input for the loop reducer is the malware binary. The output is a revised |
| | binary where all identified naive loops have been reduced, along with a report |
| | detailing the offsets of these loops and confirming whether the loop counts |
| | have been successfully reduced. |

Checking Workers. The checking stage 304 contains checking workers 308 configured to examine the malware samples for certain properties that may help subsequent modules in the exemplary system make more informed decisions about how to perform their analyses. Table 4 shows the details of each checking worker 308 (also referred to as a checker) in the checking stage 304.

TABLE 4

| Worker type | Task |
|---|---|
| Obfuscation | The obfuscation checker may identify code obfuscations by examining the |
| checker | entropy of a malware sample. High entropy values suggest a higher likelihood |
| | of obfuscation. The checker performs entropy analysis on each section of the |
| | malware binary. The checker includes a configuration parameter that allows |
| | users to set an entropy threshold; if a section's entropy exceeds this threshold, |
| | the malware may be flagged as obfuscated. The analysis excludes data sections |
| | used for storing program data, provided that these sections are detected to |
| | contain data references from code sections. The output of the obfuscation |
| | checker is a report detailing the entropy values for each section and indicating |
| | whether the malware sample is considered obfuscated based on the specified |
| | threshold. |
| Runtime | This checker may determine the runtime environment requirements by |
| environment | analyzing the statically available information in a binary. By identifying these |
| checker | requirements, subsequent modules can set up the appropriate runtime |
| | environment to ensure the malware sample executes correctly. Alternatively, if |
| | a sample meets less relevant criteria (e.g., targeting outdated systems such as |
| | Win95), the sample can be excluded from further analysis. The runtime |
| | environment checker evaluates minimum OS requirements, runtime |
| | dependencies, and user interface expectations. To evaluate the minimum OS |
| | requirement, the checker checks the binary for specific operating system |
| | dependencies to determine the minimum OS needed for execution. To evaluate |
| | runtime dependencies, the checker determines whether the sample requires |
| | specific runtimes (e.g., the Visual Basic runtime, the Visual C++ runtime, or |
| | the .NET runtime) to run properly. To evaluate the user interface expectations, |
| | the checker checks whether the malware sample requires a graphical user |
| | interface (GUI) to function as intended. |
| | The checker outputs a report listing all identified runtime environment |
| | requirements, facilitating decision-making for handling the malware sample. |

### Example Concolic Analysis Module

FIG. 3B shows an example concolic analysis module 104 of the exemplary system, in accordance with an illustrative embodiment. The concolic analysis module 104 is configured as an advanced malware analysis module, using a concolic execution engine (e.g., S2E, angr+dynamicRIO) for in-depth automated exploration and behavior analysis of malware samples 124. The concolic analysis module 104 can facilitate targeted state forking and selective symbolic constraint solving, enabling the exploration of multiple execution paths with precision. By utilizing application programming interface (API) hooking and concolic execution, the concolic analysis module 104 can examine varied behaviors, providing insights into malware operations. With the processed concolic knowledge database (e.g., 134, FIGS. 1A-1C) and advanced exploration and solving techniques, the concolic analysis module 104 can scale future analyses to newly emerging malware samples and provide insights to achieve various objectives.

Inputs and Outputs. The inputs to the concolic analysis module 104 may include (i) an executable file of a malware sample (e.g., preprocessed sample) and (ii) an optional execution configuration file for specifying parameters or constraints for the concolic analysis. The outputs of the concolic analysis module 104 may include various execution artifacts (e.g., 132, FIGS. 1A-1C), including state traces, API trace information, resolved constraints 310, system information, and performance log 312. State traces may include detailed records of the system state at key execution points, enabling step-by-step behavior mapping. API trace information may include logs of API interactions, enabling precise tracking of the malware's calls and responses. Resolved constraints 310 may include captured input values or conditions that trigger specific execution paths, facilitating targeted behavioral analysis. System information may include logs detailing environment and system interactions, including library calls and kernel driver activities, to contextualize malware behavior within its operating environment. A performance log 312 may provide performance metrics on query handling between the concolic analysis module and the constraint solver, useful for performance tuning and resource optimization.

Operation Flow. In FIG. 3B, the concolic analysis module 104 employs an emulation tool (e.g., QEMU) to execute malware samples 124 within a custom environment, monitored and controlled by tailored kernel drivers. An injector (e.g., hook installer 314) may initialize the analysis by injecting API hooks 316 (shown as analysis hooks) before launching a target program. The API hooks 316 may contain symbolic procedures for intercepting and logging sensitive API calls, enabling selective symbolization and state forking to track malware behavior with precision.

Before the concolic execution, the concolic analysis module 104 may preprocess execution configuration files (e.g., via config parser 318 and plugin installer 320) to determine which settings 322 and plugin options 324 should be enabled for the target execution. The user can specify the execution mode (e.g., directed symbolic exploration mode or full symbolic exploration mode) and choose which plugins 324 to enable or disable (e.g., ForkLimiter, MemoryMonitor, etc.). Along with the optional static guidance information generated from the static analysis service, the malware sample 124 may be transferred into a unified execution environment 330 (shown as executor). The concolic analysis module 104 may first run, via an image builder 326, a bootstrap script 328 (shown as an environment dependency setup) to further customize the execution environment 330 if the user has defined additional dependencies in the configuration and provided an installation script. After the environment 330 is prepared, a process injector (e.g., 314) may launch the malware process and inject the provided API hooks 316 into the malware process.

During execution, a tracer may monitor and trace all activities in the environment 330 and activities specific to the target malware process. When the malware sample 124 attempts to access external information (e.g., system configurations, environmental data, or network resources), the API calls are intercepted and redirected to the corresponding symbolic procedures. External inputs may be simulated as symbolic variables with constraints based on the logic of the corresponding library calls. When symbolic variables affect branching or trigger specific conditions, the concolic analysis module 104 may explore both success and failure branches, during which constraints may be collected over interactions among symbolic variables and changes in control flow. The constraints may be represented as formulas that can later be solved using satisfiability modulo theories (SMT) solvers (e.g., Z3, CVC5). Before the constraints-solving step, the concolic analysis module 104 may first interact with the concolic database (e.g., 134, FIGS. 1A-1C) to seek suggestions or even solutions if similar logic formulas have been solved (shown as resolved test cases 310). Malware samples within the same families may have similar high-level behavioral flows and generate large portions of similar constraint formulas. Thus, concolic knowledge in the concolic database (e.g., 134, FIGS. 1A-1C) can be reused to speed up analysis across samples with similar behaviors (which may be classified as the same family). After the multipath exploration and constraints solving, the concolic analysis module 104 may generate execution traces 311, performance logs 312, and other system/network artifacts.

In an example, a concolic analysis operation may be performed as follows. When a logic bomb attempts to trigger an attack on April 1 by invoking a “GetLocalTime” system call to determine the date and time, the concolic analysis module 104 may symbolize the output buffer of the “GetLocalTime” call as specified in the custom hook files. The concolic analysis module 104 may then fork execution states based on each branching condition that may involve symbolic variables derived from the output buffer. The concolic analysis module 104 may interact with a concolic database (e.g., 134, FIGS. 1A-1C) to obtain insights or candidate solutions and subsequently solve the resulting constraints using these insights. This may facilitate the concolic analysis module 104 to identify input values that satisfy one or more conditions or to verify that a given solution meets the conditions. This concolic analysis operation may reveal exact or possible input values, such as a date, that may trigger the attack.

Malware Execution Mode. To achieve targeted, scalable malware analysis, the concolic analysis module can provide the user with two malware execution modes: (i) directed symbolic exploration and (ii) full/random symbolic exploration.

The directed symbolic exploration mode is configured to target and explore specific malware behaviors. In the directed symbolic exploration, the concolic analysis module 104 can be provided with a particular target state to reach (in the form of generated control-flow information toward the target state from static analysis), which is referred to as static guidance. If the target is not reached within a set timeframe, the exploration is considered a failure for that target. The motivation behind the directed symbolic exploration mode stems from the undecidability of program behavior exploration. By focusing on a single exploration target, the concolic analysis module 104 can set up multiple instances in parallel in the directed mode. In general, the concolic analysis module 104 can (i) simultaneously explore multiple targets by isolating them individually, improving efficiency, and (ii) reduce irrelevant state forking and constraint solving, terminating non-relevant or impossible paths early, resulting in more precise analysis. Table 5 shows example operations in the directed symbolic exploration mode.

TABLE 5

| Operation | Details |
|---|---|
| Infeasible state | When static guidance (e.g., pre-configured behavior paths) is available, the |
| termination | concolic analysis module 104 may restrict exploration to a specified behavior. |
| | The concolic analysis module 104 may terminate any states that are irrelevant |
| | to the targeted behavior, enhancing efficiency and focusing computational |
| | resources on meaningful paths. |
| Static and | Static priority: To optimize path selection in concolic execution, advanced |
| dynamic state | static analysis techniques may be employed to calculate static priority, |
| prioritization | focusing on insights that span the entire program structure. Interprocedural |
| | and alias analysis can be implemented to capture cross-functional |
| | dependencies and model data flow, especially for complex structures such as |
| | pointers and references. This allows prioritization based on program-wide |
| | interactions rather than isolated function behavior, enabling a more holistic |
| | path selection. Taint analysis can further enhance static priority by tracing |
| | critical data flows, such as user inputs, to prioritize paths handling sensitive |
| | information. Adding control dependence analysis can help identify key |
| | branches that influence progression toward the target state, enabling the |
| | concolic analysis module 104 to focus on critical decision points. |
| | Additionally, heuristics for path feasibility estimation can be incorporated to |
| | minimize time spent on infeasible paths and assign weights to API calls based |
| | on their relevance to reaching target states. For a more nuanced priority |
| | model, state transitions can be represented as Markov Decision Processes |
| | (MDPs) rather than simple Markov chains, integrating probabilities and |
| | rewards to better inform path selection. To improve scalability, similar states |
| | or paths can be clustered, thereby simplifying the priority graph, reducing |
| | redundancy, and making static analysis more efficient for large-scale |
| | applications. |
| | Dynamic priority: Building on static foundations, dynamic priority can |
| | adjust path exploration in real-time based on system behavior and constraints, |
| | optimizing concolic execution responsiveness. Feedback loops can capture |
| | historical constraint-solving data, such as complexity and success rates, |
| | enabling predictions of future constraint difficulty and adjustments to path |
| | priorities accordingly. Adaptive heuristics, powered by machine learning |
| | models trained on runtime features (e.g., constraint density and branching |
| | conditions), dynamically adjust priorities based on the estimated difficulty |
| | and solvability of constraints, helping to direct focus toward feasible and |
| | impactful paths. Resource management can be handled through thresholds |
| | that control the frequency of priority updates, along with asynchronous |
| | constraint solving, allowing path exploration to continue independently of |
| | constraint-solving delays. For handling complex applications, parallel and |
| | distributed path exploration using multithreading or distributed solvers can be |
| | employed to explore multiple paths simultaneously, which balances |
| | computational overhead with improved coverage. This combination of real- |
| | time feedback, adaptive adjustments, and efficient resource use can create a |
| | responsive, resource-aware system that advances concolic execution toward |
| | accurate and efficient path exploration. |

The full/random symbolic exploration mode is a default exploration mode when static guidance is unavailable. In full/random symbolic exploration, the concolic analysis module 104 can apply the symbolic procedures defined in the API hooks 316 and use a custom state manipulation algorithm to explore all reachable program states. The full/random symbolic exploration mode can capture various behaviors, serving as a fallback when directed symbolic exploration may have prematurely terminated valid paths, ensuring comprehensive behavior coverage. In the full/random symbolic exploration mode, the concolic analysis module 104 can explore all program states and behaviors without any static guidance. Using symbolic procedures and custom algorithms within the hooks 316, the concolic analysis module 104 can traverse every feasible state, providing an extensive map of potential malware behaviors for thorough analysis.

Unified Malware Execution Environment. The unified malware execution environment 330 is configured to handle various malware samples and satisfy various malware triggering conditions. The environment 330 is configured to accommodate the requirements of executing malware samples, including driver support across multiple modules and software dependencies, to ensure a robust, pre-configured, isolated malware analysis setup. Table 6 shows example requirements for the unified malware execution environment 330.

TABLE 6

| Requirement | Details |
|---|---|
| Driver | The environment 330 may be configured to handle a wide array of driver |
| support | requirements, including custom drivers A-Z, with pre-defined access controls |
| | for dynamic behavior tracking. |
| Software | Software dependencies may be pre-installed software packages commonly |
| dependencies | required by malware samples, such as Python 2.7, legacy communication |
| | tools (e.g., BlueJeans), and other runtime environments that malware may |
| | exploit. |
| Isolation | The environment 330 should have robust containment measures to protect the |
| and security | host environment while providing flexible networking options (e.g., simulated |
| | internet access). |
| Automation | The environment 330 should include automated configuration scripts to |
| | minimize manual setup and facilitate reproducibility for each malware |
| | sample. |

Table 7 shows example configurations or implementations for each requirement of a unified malware execution environment 330 shown in Table 6.

TABLE 7

| Configuration/ | |
|---|---|
| Implementation | Details |
| Driver installation | Scope: Drivers A-Z can be included, covering common and obscure driver |
| | functionalities often used or exploited by malware samples. |
| | Implementation: A modular driver deployment system can be used where |
| | individual driver modules are pre-installed and validated. Startup checks can |
| | be implemented to ensure that each driver is operational and isolated. |
| | Logging can be configured to capture driver-related events and API calls for |
| | post-execution analysis. |
| Software dependency | Python 2.7: Python 2.7 can be pre-installed and configured in the |
| setup | environment 330, setting up system paths and required libraries (e.g., pip, |
| | requests). |
| | BlueJeans and other communication tools: Legacy versions of |
| | communication tools may be installed for malware communication analysis. |
| | Application logging can be configured to monitor and record network |
| | interactions. |
| | Additional software: A dependency management list for tracking other |
| | software can be established, such as Java or C/C++ runtimes. Version- |
| | controlled scripts can be used to standardize software installations, ensuring |
| | compatibility across analysis instances. |
| Isolation and | Virtual machine (VM) isolation: All malware samples should be deployed |
| networking controls | within isolated VMs that include software-defined networking to simulate |
| | external connections safely. |
| | Networking simulation: Options for simulated internet access should be |
| | included, with a configurable domain name server (DNS) and network |
| | sandboxing. Traffic capture may be configured with customizable filtering |
| | options to monitor and log network activity. |
| Automation and | Configuration scripts: Automated scripts can be developed to handle the |
| reproducibility | whole setup process, including software installations, driver deployment, and |
| | networking configurations. The automated scripts should validate installations |
| | and perform health checks to ensure the environment 330 meets execution |
| | requirements. |
| | Version control: Version-controlled configurations and package lists can be |
| | used to manage dependencies, maintaining a consistent environment state for |
| | each analysis. |

The unified execution environment 330 is further configured to be extensible, allowing future additions of software dependencies or driver updates. This modular approach enables rapid adaptation to new malware requirements, ensuring the exemplary system remains relevant for evolving malware analysis needs.

Concolic Database. The concolic database (e.g., 134, FIGS. 1A-1C) is configured to store concolic knowledge and heuristics from previous analysis processes, along with domain knowledge, to speed up and scale the analysis of new samples. The concolic database (e.g., 134, FIGS. 1A-1C) can be used in two modes: (i) local knowledge database and (ii) global knowledge database. Table 8 shows example operations in the local knowledge database mode of the concolic database (e.g., 134, FIGS. 1A-1C).

TABLE 8

| Operation | Details |
|---|---|
| Constraint | Operation flow: During execution, each constraint solved by the concolic |
| caching and | analysis module 104 can be stored in a cache with a unique (or similar with |
| storage | relaxation) identifier (e.g., a hash of the constraint) and its solution. The cache |
| | can be implemented as a hash table or symbolic execution tree (SET) for |
| | lookup. |
| | Retrieval mechanism: When the concolic analysis module 104 encounters a |
| | constraint, the module can first check the cache. If a match is found, the |
| | concolic analysis module 104 can retrieve the solution directly, bypassing re- |
| | solving. If not, the concolic analysis module 104 can solve the constraint and |
| | add the solution (e.g., 310) to the cache. |
| | Pruning strategy: To manage cache size, an LRU (Least Recently Used) |
| | eviction policy can be used to retain frequently used or high-impact entries. |
| | Additionally, relevance scoring can help prioritize entries based on recent |
| | usage patterns or runtime data. |
| Dynamic | Operation flow: Runtime data such as path execution frequency, constraint |
| heuristic | complexity, and branching information can be fed back into the heuristics, |
| adjustment | which can dynamically adjust exploration priorities. The runtime data can be |
| | stored in the database and updated periodically to keep heuristics responsive. |
| | Subsumption checking: New constraints can be checked against existing |
| | ones to detect if they are subsumed by those already solved. If they are, the |
| | concolic analysis module 104 can skip further processing, reducing redundant |
| | storage and computational costs. |
| Parallel | Operation flow: The concolic analysis module 104 can use parallel |
| solving and | processing to handle multiple constraints simultaneously. Paths can be queued |
| asynchronous | with priority based on their calculated utility, ensuring the most promising |
| exploration | paths are explored first. |
| | Knowledge pruning: As paths are explored, stale or redundant entries can be |
| | periodically removed from the database to optimize memory and improve |
| | lookup speeds, maintaining an efficient local database for real-time reuse. |

Table 9 shows example operations in the global knowledge database mode of the concolic database (e.g., 134, FIGS. 1A-1C).

TABLE 9

| Operation | Details |
|---|---|
| Central | Operation flow: Each instance of the concolic analysis module 104 can |
| repository for | upload relevant constraints, solutions, and execution insights to a central |
| knowledge | repository (or in a peer-to-peer setup). Unique (or similar with relaxation) |
| sharing | constraint signatures and metadata (e.g., program version, environment, input |
| | parameters) may help organize entries, enabling compatibility checks across |
| | different instances. |
| | Normalization and template matching: Constraints can be stored in a |
| | normalized form (e.g., via abstract syntax trees or generic templates), |
| | simplifying their comparison across similar but non-identical code samples. |
| | When a new sample is analyzed, the concolic analysis module 104 can search |
| | the repository for reusable knowledge entries. |
| Metadata and | Operation flow: Each knowledge entry can be tagged with metadata to |
| confidence | ensure its relevance for specific versions or environments. Confidence scores |
| scoring | (e.g., derived from the reliability of previous uses) can be associated with |
| | entries, guiding the module's prioritization for reuse in new executions. |
| | Conflict resolution: To manage conflicting or outdated entries, versioning |
| | systems can track entry updates, while consensus protocols can validate and |
| | integrate changes from multiple sources. This may ensure a consistent and up- |
| | to-date knowledge base across instances. |
| Security and | Operation flow: Authentication and encryption may be mandatory for all |
| scalability | data transactions to protect sensitive data. A distributed storage solution |
| | paired with load balancing may ensure the database can handle high data |
| | volumes and maintain rapid access for all instances. |
| | Pattern recognition and predictive analysis: Machine learning models can |
| | analyze stored entries for common patterns across code samples. Predictive |
| | analysis can rank paths based on likely coverage of unexplored behaviors, |
| | directing the concolic analysis module 104 toward high-value exploration |
| | areas for similar new samples. |

### Example Task Generation Module

The task generation module (e.g., 106, FIGS. 1A-1C) is configured to process API sequences and their associated arguments from other modules to create dynamic tasks for execution. The task generation module (e.g., 106, FIGS. 1A-1C) can ingest API sequences, determine required environment customizations, and generate dynamic tasks (e.g., 360, FIG. 3D) and network packets (e.g., 362, FIG. 1D) (e.g., request-response pairs) for each sequence. Additionally, the task generation module (e.g., 106, FIGS. 1A-1C) can identify which system artifacts to generate based on real API sequences from actual executions, following the same logic.

Inputs and Outputs. The inputs to the task generation module (e.g., 106, FIGS. 1A-1C) may include API sequences with their associated arguments, which can come from logs of executed API calls with corresponding arguments, test cases generated for certain symbolic variables from the concolic analysis 104, or from any execution traces (e.g., within the set of execution artifacts 132, FIGS. 1A-1C) of actual executions.

The outputs of the task generation module (e.g., 106, FIGS. 1A-1C) may include dynamic task files (e.g., 360, FIG. 3D) and network packets (e.g., 362, FIG. 1D). A dynamic task file (e.g., 360, FIG. 1D) is an extensible JavaScript Object Notation (JSON) file that supports various system-setting operations to prepare an environment that enables malware to manifest its behaviors. The dynamic task file (e.g., 360, FIG. 1D) can specify operations such as file system manipulations (e.g., creating, modifying, or deleting files), environment variable settings, and registry modifications (e.g., creating, modifying, or deleting registry keys and values). A network packet (e.g., 362, FIG. 1D) is an extensible JSON file containing request-response pairs; each network packet (e.g., 362, FIG. 1D) may include fields extracted from system API arguments and test cases.

Operation Flow. The task generation module (e.g., 106, FIGS. 1A-1C) can identify and map symbolic variables to corresponding system API arguments in its inputs. The task generation module (e.g., 106, FIGS. 1A-1C) can then categorize API sequences (e.g., from execution artifacts 132, FIGS. 1A-1C) into operation types while maintaining their execution order. The task generation module (e.g., 106, FIGS. 1A-1C) can then analyze each API sequence, using a state machine-based log parser, to generate specific operations and extract the parameters required, such as file creation details (e.g., file name and content). The task generation module (e.g., 106, FIGS. 1A-1C) can then create both the dynamic task file (e.g., 360, FIG. 1D) and the network packet file (e.g., 362, FIG. 1D) for each state (of the state machine-based log parser). The dynamic task file and network packet file for each state is for the different execution state in the concolic execution module, not for the state in the state machine-based log parser.

### Example Rewriter Module

FIG. 3C shows an example rewriter module 110 of the exemplary system, in accordance with an illustrative embodiment. The rewriter module 110 can ensure a malware sample 124 exhibits only behaviors observed in prior analysis modules (e.g., triage, concolic). The malware 124 should not execute any instructions that are not examined in prior analysis modules. The rewriter module 110 is configured to rewrite the malware sample 124 using a hybrid approach that combines binary rewriting with source code rewriting.

Inputs and Outputs. The input to the rewriter module 110 may include a malware sample 124 to rewrite, and execution traces 146 generated from the analysis modules (e.g., concolic analysis module 104). The execution traces 146 may be associated with metadata that may contain the behaviors identified by the taxonomy module (e.g., 160, FIG. 1B). The output of the rewriter module 110 may be a set of rewritten binaries 152 (multiple or none) (e.g., a rewritten malware sample) and the source code files 340 (also multiple or none). The source code files 340, if generated, can be compiled into the corresponding rewritten binaries.

Operation Flow. After receiving the inputs, the rewriter module 110 can pass the inputs to two pipelines in parallel: the binary rewriter 148 and the source code rewriter 150. Each pipeline can generate one or multiple rewritten binaries 152, and the source code rewriter 150 can further produce the corresponding source code 340. The outputs from both pipelines can be aggregated as the final result.

The binary rewriter pipeline 148 can modify the malware binaries 124 to remove all unexecuted code through two sub-pipelines: a static rewriter 346 and a dynamic rewriter 348. The static rewriter 346 can begin by analyzing coverage information from all execution traces 146 to identify the instructions executed. The static rewriter 346 can first disassemble the malware binary 124 to locate all executable instructions, then check which instructions were executed according to the execution traces 146. The static rewriter 346 can then rewrite all instructions that were not executed with an instruction that triggers an exception (e.g., INT3 on the x86 architecture), ensuring that whenever execution reaches a rewritten instruction, the malware 124 may terminate due to an unhandled exception. The dynamic rewriter 348 can handle scenarios in which instructions are generated at runtime, such as within compressed or encrypted payloads. The dynamic writer 348 can perform dynamic binary rewriting by identifying control-flow transfer instructions that jump into newly generated code and hooking them with a dynamic rewriting stub. The dynamic rewriting stub can perform similarly to the static rewriter 346 by rewriting unseen instructions with exception-triggering instructions, and by hooking any additional control-flow transfer instructions (in the newly generated code) with new stubs to handle dynamically and recursively generated code. This ensures that in dynamically generated regions, any instruction not seen during analysis (e.g., concolic analysis 104) may also trigger an exception, thereby terminating the malware 124.

To ensure that the generated exception is not handled by the malware 124 itself (which would prevent termination), the rewriter module 110 may include a safety mechanism. After rewriting, the rewriter module 110 can execute the malware 124 in debug mode, forcing it into regions that have been rewritten. The rewriter module 110 can then verify that execution halts at the point where it reaches an unseen instruction. If the rewriter module 110 finds any unseen instructions still being executed (e.g., the exception was handled by the malware 124), the rewriter module 110 can use a different exception-triggering instruction (e.g., UD2 for x86). The rewriter module 110 can repeat the safety check until the rewriter module 110 finds an instruction that cannot be caught. If none of the exception-triggering instructions prevent the malware 124 from executing unseen instructions, the rewriter module 110 can consider the rewriting unsuccessful and escalate the issue with detailed debug information for a user to investigate.

The source code rewriter pipeline 150 can regenerate new binaries 152′ from source code 340′ and verify (350) that these newly generated binaries 152′ exhibit the same behaviors as the input malware binary 124 (e.g., accepted as rewritten output 152), with respect to the provided execution trace 146. The source code rewriter pipeline 150 can generate new binaries 152′ through an agentic system. The agentic system can combine AI or LLM agents (e.g., rewriter agent 342) with tools 352 to generate a new malware sample 152′ in one or more programming languages (e.g., C or C++). The tools 352 may include build systems (e.g., build agent, compiler) for the target languages (e.g., GCC for C) and other components in the exemplary system, such as the dynamic execution environment. The rewriter agent 342 can operate in an iterative loop that refines the generated malware 152′ until the malware 152′ is verified to exhibit the intended behaviors (e.g., accepted as rewritten output 152). First, the rewriter agent 342 can be prompted with initial information, including instructions to generate a program in the first supported programming language (e.g., C), the intended APIs, the corresponding behavior sequences, and, optionally, partial de-compilation of the malware binary as a learning example. Table 10 shows an example prompt in C language to configure/program the rewriter agent 342. Second, the rewriter agent 342 can generate a response that includes a source code 340′. Third, the rewriter agent 342 can use the corresponding build system 352 to compile the code 340′. If build errors occur, the errors can be collected and sent back to the rewriter agent 342 to provide a corrected version. The iterative loop can continue until the code 340′ builds successfully (e.g., accepted as output source code 340) or a configurable iteration limit is reached.

The outputs from the binary rewriter pipeline 148 and the source code rewriter pipeline 150 can be aggregated into a final output that may contain a list of tuples. Each tuple may include (i) a rewritten binary 152, and (ii) the corresponding source code 340 and build instructions, if the source code rewriter 150 generated the binary.

TABLE 10
“You are an expert C programmer specializing in Windows API
programming. Your task is to generate valid, compilable C code that uses
specific Windows APIs.
## Your Responsibilities
1. Generate complete, standalone C source code
2. Include all necessary headers (windows.h, stdio.h, etc.)
... <additional instructions>
## Common Windows API Patterns
... <RAG-based relevant API documentation>
## Output Format
... <description of required format>
## Example Structure in C
... <example code patterns>
## Example Structure from the Original Binary
... <partial decompilation as a reference>
... <other engineered instructions to improve performance>”

### Example Verifier Module

FIG. 3D shows an example verifier module 108 of the exemplary system, in accordance with an illustrative embodiment. The verifier module 108 is configured to verify and execute/deploy a malware binary sample 124 (e.g., before or after rewriting) in a dynamic execution environment that facilitates environment customization, program execution tracing, system event monitoring, and out-of-control termination.

Dynamic Execution Environment. The inputs to the dynamic execution environment may include (i) a malware sample 124 (e.g., triaged malware sample/binary) to be executed in isolation and (ii) a dynamic task 360 (e.g., from the task generation module 106) (e.g., configuration file specifying environment customizations). The outputs of the dynamic execution environment may include a dynamic execution trace (e.g., 146, FIGS. 1A-1C) (e.g., a record of program execution) and system event log 364 (e.g., for events occurring during the dynamic execution).

In some embodiments, the dynamic execution environment is a virtual machine (VM) or a cluster of bare-metal host machines that includes one network proxy node (e.g., of network proxy 368) and multiple dynamic execution nodes. The dynamic nodes can be configured with a host-only network and use the network proxy node as their gateway, enabling controlled network monitoring, filtering, and morphing.

In an operation flow, the dynamic execution environment can first restore the dynamic execution node to a clean state using pre-configured snapshots. The dynamic execution environment can then use the dynamic task file 360 to apply environment customizations within the execution node. The dynamic execution environment can then copy the malware sample 124 (e.g., a triaged malware sample/binary) to the execution node and execute it, using a customized monitoring and tracing tool (e.g., DynamoRIO) to track program execution and collect trace data (e.g., execution traces). The dynamic execution environment can then export the collected trace data (e.g., 146, FIGS. 1A-1C) and system event log 364 from the execution node.

Execution Trace Verifier. The inputs to the trace verifier 144 (also referred to as a trace comparator) may include execution traces from the dynamic execution and/or the concolic analysis (e.g., 104, FIGS. 1A-1C). The outputs of the trace verifier 144 may include (i) similarity scores between the input execution trace 311 (e.g., within the set of execution artifacts 132, FIGS. 1A-1C) and the dynamic execution trace (e.g., 146, FIGS. 1A-1C) at various levels of verification, including basic-block, API, and system-event levels, and (ii) verified dynamic execution traces 366 (e.g., dynamic execution traces 146 that are verified).

The trace verifier 144 is configured to verify the accuracy of the dynamic execution compared to prior analysis results (e.g., from triage or concolic). In an operation flow, the trace verifier 144 is configured to perform three levels of verification, including the basic-block level, the API level, and the system-event level. At the basic-block level, the trace verifier 144 is configured to verify a match between a basic-block sequence in the dynamic execution trace (e.g., 146, FIGS. 1A-1C) and the analysis result (e.g., concolic analysis result). At the API level, the trace verifier 144 is configured to verify a match between an API call sequence in the dynamic execution trace (e.g., 146, FIGS. 1A-1C) and the analysis result (e.g., concolic analysis result). At the system-event level, the trace verifier 144 is configured to verify an alignment between system event effects from dynamic execution and the analysis result (e.g., concolic analysis result). In some embodiments, the trace verifier 144 is configured to check at each level whether the two traces are exact match in terms of basic block or the two traces have the same system-events set. Passing all the three levels of verification gives a success verification or otherwise the deviations will also be sent to the next module.

Network Proxy. The network proxy 368 is configured as an application-layer proxy for malware traffic, enabling complete control over traffic flow and content. Integrated with a fake Command and Control (C&C) server 370, the network proxy 368 can use network packets 362 generated by the task generation module (e.g., 106, FIGS. 1A-1C) to emulate realistic malware communications. By issuing C&C commands to the malware, the network proxy 368 can enable controlled and realistic network interactions for malware analysis.

In an example operation flow, the network proxy 368 can first receive network packets 362 generated by the task generation module 368. A dynamic execution environment (also referred to as a client) can then (i) start with a specific Internet Protocol (IP) associated with a malware ID, and (ii) run, before executing the malware sample, a setup script to configure the network proxy 368 and register a binding (e.g., IP and malware ID) in a binding database of the network proxy 368. The network proxy 368 can intercept outgoing requests from the dynamic execution environment and direct them to the C&C server 370. The dynamic execution network (e.g., client) can then (i) wait for the response back from the C&C server 370, and (ii) receive the corresponding malware ID from the binding database based on the IP at the proxy/fake C&C.

To respond to a request from the dynamic execution environment (e.g., client), the network proxy 368 can perform a fuzzy match to determine whether a record (e.g., IP and malware ID) exists in the binding database for that request. If the C&C is alive and analyzed, the network proxy 368 can retrieve a matching record from the binding database and respond to the dynamic execution environment based on predefined rules, prioritizing either fake or live C&C responses. If the C&C is alive but not analyzed, or if the malware does not issue the request, the network proxy 368 can forward the request to the C&C server 370 and send the response from the server to the dynamic execution environment. If the C&C is not alive but has been analyzed, the network proxy 368 can retrieve the record from the binding database and send the record back in response to the request. If the C&C is not alive and not analyzed, the network proxy 368 can send a fake, predefined response to the dynamic execution environment since no record can be found in the binding database.

In some embodiments (e.g., real deployment), stronger security censorship can be configured for the network proxy 368 to control the malware traffic. For example, only allowing the dynamic execution environment (e.g., client) to access a specific domain or IP by adding programmable plugins.

### Example Taxonomy Module

FIG. 3E shows an example taxonomy module 160 of the exemplary system, in accordance with an illustrative embodiment. The taxonomy module 160 is configured to establish a baseline for defining malware samples' behaviors based on their API usage. In some embodiments, the taxonomy module 160 includes three main components: a behavior identification component 372, an evaluation dataset recommendation component 374, and a measurement component 376. The behavior identification component 372 is configured to map API usage to behaviors. The result generated from the behavior identification component 372 can be collected into a behavior database 164 over time, laying a foundation for (i) the evaluation dataset recommendation component 374 (shown as recommendation system) to generate datasets with target coverage (shown as recommended data set 378) to evaluate the performance of any malware analysis product, and (ii) the measurement component 376 to provide up-to-date, insightful studies, such as trace-level and sample-level behavior growth measurement.

Behavior Identification Component. The behavior identification component 372 is configured to map API usage to behaviors achieved by the APIs. The input to the behavior identification component 372 can be an API usage 380, which can take two forms: API set and API sequence. The API usage 380 can be an API set when focusing on the presence of APIs, such as all APIs present in a malware sample (e.g., 124, FIGS. 1A-1C). The API usage 380 can be an API sequence when the presence and uniqueness of sequencing are considered, such as APIs sequentially invoked in execution traces. The API usage 380 can be from various levels of sources, such as basic blocks, functions, execution traces, and samples. Such multi-level sources can facilitate studying malware behavior patterns at different granularities during the measurement component 376.

The outputs of the behavior identification component 372 can be system behaviors 382 achieved by the given API usage 380, such as operations on the filesystem, network, and registry. If the API usage input 380 is an API set, the output is a behavior set 382 containing behaviors whose Boolean API matching tree is satisfied. If the API usage input 380 is an API sequence, the output 382 is a sequence of behaviors, representing the sequence of new behaviors that appear as APIs progressively occur in the input.

In an operation flow, if the API usage input 380 is an API set, the behavior identification component 372 can evaluate the satisfiability of a Boolean API matching trees corresponding to each behavior (e.g., behavior 1=AND: {API1, API2}, behavior 2=OR:{AND:{API1, API2}, API3}). A behavior is considered matched if its corresponding API matching tree is true on a given API set. If the API usage input is an API sequence, the behavior identification component 372 can first convert the sequence into a list of progressively increasing API sets, then sequentially perform the same behavior identification method on these API sets.

In some embodiments, the mapping 372 from an API sequence to a behavior sequence is data-dependency-based. During the generation of the API sequence from an execution, the sequence can be partitioned into subsequences based on the data dependencies of its arguments. For example, APIs that operate on the same uniquely identifiable resource (e.g., a specific file handle) can be grouped into a single subsequence. This dependency-based grouping can model the correlation and continuity among APIs that manipulate the same underlying resource.

Within each API subsequence group, the taxonomy module 160 can iterate through the APIs in order and record the corresponding sequence of matched behaviors 382, serving as the output behavior sequences. In addition to data-dependency-based mapping, the taxonomy module 160 may employ other mapping methods. For example, the taxonomy module 160 may employ an n-gram-based mapping method that segments the API sequence into overlapping subsequences of length n and maps each n-gram to one or more behaviors.

The behaviors 382 can be organized into a three-layer hierarchy, from the most abstract to the most fine-grained (e.g., layer 1: communication, layer 2: socket communication, layer 3: receive data on socket), to provide a description of malware behaviors at different levels of abstraction. The output behaviors 382 can be continuously collected into a behavior database 164 to power the evaluation dataset recommendation component 374 and the measurement component 376. The API Boolean matching trees may follow the industry-standard capa-rules (e.g., the “feature” field). The definitions of layer 1 and layer 2 may follow the MITRE ATT&CK categorization and the malware behavior catalog used by the capa-rules, with custom post-processing to merge similar behaviors. The definition of layer 3 may be the “name” field of the capa-rules.

Behavior Database. The behavior database 164 is configured and continuously updated based on the results generated by the behavior identification component 372. A primary field of the database 164 can be the 256-bit Secure Hash Algorithm (SHA256) of a malware sample. The other fields of the database 164 may include “malware family”, “discovered date”, “malicious score”, and “behaviors” (e.g., sets and sequences). The “malware family” field can be defined based on the “behaviors” field. The “discovered date” field can be the first time the malware sample is reported. The “malicious score” field can quantify the malware sample's maliciousness, computed from the number and severity of its behaviors. The “behaviors” field can include basic-block-level behaviors, function-level behaviors, execution-trace-level behaviors, and sample-level behaviors. Each “behavior” field can also include APIs that comprise the behaviors, along with the addresses of the API calls within the malware sample.

Evaluation Dataset Recommendation Component. The evaluation dataset recommendation component 374 is configured to generate datasets with target coverage (e.g., set of APIs, set of behaviors) as benchmarks to evaluate the performance of any malware analysis product.

The inputs to the evaluation dataset recommendation component 374 may include data from the behavior database 164 and target coverage criteria 384 that the output evaluation dataset 378 should cover. The target coverage criteria 384 can contain (i) any (combination of) fields supported by the behavior database 164 and size limit of the dataset, and (ii) an optional “minimal dataset” flag that signals the recommendation component 374 to provide the smallest possible dataset satisfying the target coverage.

The output 378 of the evaluation dataset recommendation component 374 may be a sample dataset satisfying the given target coverage criteria 384 for evaluating any malware analysis product.

In an operation flow, the recommendation component 374 can generate SQL queries based on the input target coverage criteria 384 and then retrieve a dataset that satisfies the criteria 384. Additionally, when an optional “minimal dataset” flag is specified, the recommendation component 374 can further reduce the dataset to a minimal set that achieves the target coverage (e.g., via linear programming) to reduce the workload for later analysis while maintaining the same coverage.

Measurement Report Component. Based on data collected from the behavior database 164, the measurement component 376 can provide a diverse set of functionalities for measuring the growth of unique APIs and behaviors as the number of units (e.g., basic blocks, functions, execution traces, behaviors (for measuring API growth only), samples, families) grows. The measurement component 376 can support various types of measured targets (i.e., APIs and behaviors), including individuals, sets, and sequences, to suit multiple needs. The measurement includes, but is not limited to, distribution measurement, growth measurement, and similarity measurement of APIs and behaviors. The generated reports can have multiple applications, such as studying the evolution of malware behaviors over time, providing threat intelligence on techniques deployed by attackers, and enhancing malware detection based on the insights from behavior/API distributions to improve accuracy.

The inputs to the measurement component 376 may include data from the behavior database 164, the measured target, and an optional target for similarity measurement. The outputs of the measurement component 376 may include measurement reports.

In an operation flow, based on data obtained from the behavior database 164, the measurement component 376 may generate key-value pairs that associate units (e.g., basic blocks, functions, execution traces, behaviors, samples, families) with corresponding measured targets contained within each unit (e.g., individual APIs or behaviors, sequences of APIs or behaviors, sets of APIs or behaviors), before performing specific measurement operations. The measurement component 376 can provide a histogram of the distribution of behavior sequences/sets among the units. The measurement component 376 can also support cluster-based distribution, in which a distribution is measured across clusters of similar behavior sequences/sets. The cluster-based distribution can provide insights into common/scarce attack workflows deployed by malware and their evolution over time.

The measurement component 376 can provide a plot of growth in behavior coverage within the units (also referred to as a growth plot) as the dataset of the units (e.g., output evaluation dataset) grows. The targets in the growth plot may include individual behavior measurement, behavior sequence measurement, and behavior set measurement. The individual API/behavior measurement can track the growth in the number of unique APIs/behaviors as the number of units in the dataset increases. The API/behavior sequence measurement can track the growth in the number of unique API/behavior sequences as the number of units in the dataset increases. In some embodiments, a behavior sequence is defined as an ordered list of behaviors chronologically observed in an execution trace. The API/behavior set measurement can track the growth in the number of unique API/behavior sets as the number of units in the dataset increases. In some embodiments, a behavior set is defined as an unordered set of behaviors observed in an execution trace/within a malware sample.

Because the space of distinct malicious behavior patterns is finite, analysis of a sufficiently large number of samples may lead to behavioral convergence (i.e., after this point, additional samples do not reveal materially new behaviors). Rewritten samples generated from the set of samples analyzed up to the convergence point may constitute a malware dataset that is minimal in size while still capturing the full set of behaviors observed. The malware dataset can then be used in downstream applications, e.g., to evaluate intrusion detection systems (IDSes) comprehensively (via saturated behavior coverage) and efficiently (via a minimized number of samples).

Given an API/behavior sequence/set, the measurement component 376 can identify similar targets in the behavior database 164 for analysis, which is useful for discovering new malicious execution traces and new families of samples when no candidates with high similarity are found in the behavior database 164.

The measurement component 376 can provide multiple options for similarity metrics (e.g., Longest Common Subsequence (LCS), Cosine Similarity, Jaccard Similarity, Levenshtein Distance (Edit Distance)) and clustering methods (e.g., DBSCAN, Gaussian Mixture Models (GMM), Hierarchical clustering).

Machine Learning (ML) Model Training based on Behavior Database. The behavior database 164 may facilitate the training of AI or ML models (e.g., AI or LLMs) for tasks such as malware detection, classification, and attribution. The multi-level behavioral fields of the behavior database 164 can serve as inputs for supervised or unsupervised learning algorithms. For example, behavior sets and behavior sequences in the behavior database 164 can be transformed into feature vectors for behavior-based malware classifiers; temporal patterns in behavior sequences can be used to train sequence models; and the malicious score can serve as a supervisory label.

The behavior database 164 can support periodic retraining and continuous-learning pipelines, allowing AI or ML models (e.g., AI or LLMs) to adapt as new malware behaviors emerge. The behavioral fields of the database 164 can also facilitate advanced tasks such as family-level clustering, zero-day behavior pattern mining, and cross-sample similarity modeling. Overall, the behavior database 164 can provide a corpus for systematic, data-driven ML model development and evaluation.

### Example Job Dispatcher and User Interface

Job Dispatcher. In some embodiments, the exemplary system employs a producer-consumer model to facilitate automated, scalable malware analysis. Central to the producer-consumer model is a job dispatcher, configured to allocate analysis tasks (or jobs) across multiple independent workers (e.g., preprocessing workers, checking workers), each of which may perform specific analysis tasks (e.g., triage preprocessing task, triage checking task). Each analysis module (e.g., triage, concolic) may have a dedicated dispatcher managing a predefined number of parallel workers (e.g., preprocessing workers, checking workers), which may remain on standby to execute assigned tasks and report results upon completion. Encapsulated in Docker containers, the number of workers can be scaled to accommodate workload demands.

User Interface. The exemplary system provides a dual interface that includes a web-based Graphical User Interface (GUI) and a Command Line Interface (CLI), accommodating different user preferences and operational needs. The GUI provides an intuitive, versatile, and device-independent interface that can facilitate users to visually construct analysis pipelines via drag-and-drop to customize workflows, upload target samples for analysis, and monitor analysis results.

Upon completing the triage analysis, the GUI can generate a control flow graph of the malware sample, facilitating users to annotate “interesting” or “uninteresting” paths in the control flow. The annotations may subsequently be communicated to the concolic analysis module 104, guiding the concolic analysis module 104 in prioritizing relevant paths for deeper analysis. For example, the concolic analysis module 104 can prioritize paths marked as “interesting” and deprioritize those marked as “uninteresting”. The GUI can also support collaborative efforts, allowing the users to share real-time and historical analyses, thereby fostering teamwork on complex malware samples.

For environments requiring headless operation or automation, or for users who prefer a streamlined, headless mode, the CLI can provide an alternative to the GUI. CLI can facilitate the users to submit tasks, configure pipelines, and retrieve results in a streamlined command-based format.

### Additional Security Configurations

The exemplary system prioritizes security by implementing isolation, containment protocols, and network controls to mitigate risks associated with malware analysis. Each worker (e.g., preprocessing, checking) within the exemplary system may operate in a dedicated Docker container, ensuring strict process isolation and minimizing the potential impact of malicious activity. By enforcing a boundary around each analysis task, the exemplary system can prevent cross-contamination between modules and restrict malware's ability to affect the host system.

All containers can be connected through a centralized network proxy that filters and inspects traffic before it reaches the external Internet. This network setup can achieve controlled communications with the external Internet, limit unauthorized outbound communications, and provide a mechanism to monitor all network traffic, thereby containing any malicious network activity that may arise during malware analysis.

To protect organizational infrastructure, the exemplary system is isolated from the enterprise network, ensuring that any risk of containment breach is confined within the controlled environment of the exemplary system. This isolation setup can prevent any potential threats from impacting the broader enterprise network.

The exemplary system can implement a logging system to track all malware analysis activities, behavior triggers, and user access. Logs are protected from tampering and unauthorized access through encryption and strict access controls, ensuring data integrity. The exemplary system can also establish data retention policies, with automated log expiration and secure data purging after a predefined period, to prevent unauthorized access and minimize risk in the event of a security breach. Additionally, the logs can provide traceability to facilitate debugging and response in case of failure.

The exemplary system can provide an update mechanism for all modules so that the exemplary system can remain effective against new and evolving malware behaviors. All updates may be signed, verified, and accompanied by checksums to prevent tampering or unauthorized code injection. Additionally, the exemplary system can roll back updates to maintain stability and continuity in the event of any update issues.

### Example Artificial Intelligence (AI) and Machine Learning (ML) Models

Machine Learning. In addition to the machine learning features described above, the exemplary system can be implemented using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Experimental Results and Additional Examples

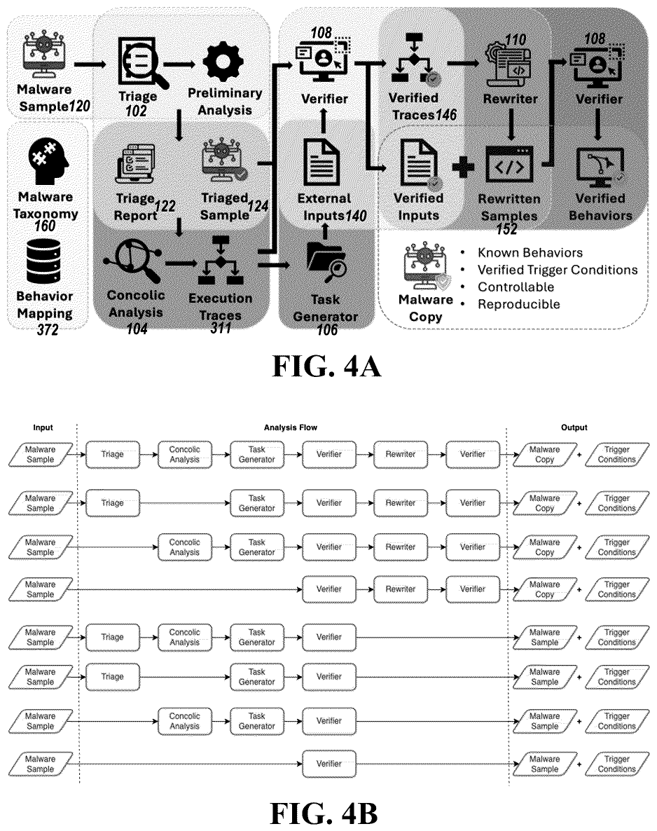

A study was conducted to develop and evaluate an experimental system (also referred to as “MalwareLab”) comprising a triage module 102, a concolic analysis module 104, a task generation module 106 (also referred to as task generator), a trace verifier module 108, a rewriter module 110, and a taxonomy module 160, as described in FIGS. 1-3. The development of the experimental system involved (i) establishing an infrastructure that handled large-scale, automated malware analysis with security measures, (ii) installing and configuring the components (e.g., analysis modules, data storage, etc.) of the experimental system, and (iii) updating the modules (e.g., taxonomy) and software patches of the experimental system. FIG. 4A shows the experimental system of the study.

Infrastructure Preparation. To deploy the experimental system, the study developed a dedicated, isolated infrastructure that could securely manage and analyze malware samples. Table 11 shows the steps for the infrastructure setup.

TABLE 11

| Step | Details |
|---|---|
| Environment | The study deployed the experimental system in an isolated environment, such as |
| segmentation | a private cloud (e.g., Proxmox or OpenStack) or on-premises setup, ensuring the |
| | experimental system was separated from production networks and sensitive data. |
| | The study used virtual local area networks (VLANs) and firewalls to segment the |
| | experimental system's environment, providing an additional layer of protection. |
| Sandboxed | Each analysis node operated in a sandboxed environment to securely handle live |
| execution | malware samples. Virtualization (e.g., QEMU, VMware) or containerization |
| nodes | (e.g., Docker) was employed for each node, providing controlled environments |
| | for executing and analyzing malware behaviors. |
| Scalable | The infrastructure was scalable to meet varying workload demands, particularly |
| resource | for handling complex or high volumes of malware. This could involve dynamic |
| allocation | provisioning in a cloud environment or using load balancers to manage resource |
| | distribution. |

Core Component Installation. The experimental system included several core components that could be installed and configured for functional operation. Table 12 shows the steps for installing and configuring the core components of the experimental system.

TABLE 12

| Step | Details |
|---|---|
| Analysis | The study developed, for the experimental system, an analysis pipeline that |
| pipeline | included a triage module, concolic analysis module, task generation module, |
| development | verifier module, and rewriter module, as shown in FIG. 4A. The analysis pipeline |
| | was configured to process malware samples, extract behavior, and classify them |
| | into the taxonomy (as described in FIGS. 1 - 3). The analysis pipeline was |
| | deployed on high-performance servers, enabling parallel processing to maximize |
| | throughput. Resource allocation settings were configured to adjust automatically |
| | based on pipeline load. |
| Database | The study deployed relational (e.g., PostgreSQL), document-based (e.g., |
| setup | MongoDB), and in-memory cache (e.g., Redis) databases to support the |
| | experimental system and store metadata, behavior taxonomies, and analysis |
| | results. PostgreSQL handled structured data, while MongoDB managed |
| | unstructured data for flexible storage and querying. Both databases were backed |
| | up regularly and secured with access controls. |
| Storage | The study configured high-capacity, high-speed storage for storing malware |
| solutions | samples, rewritten variants, and logs. Distributed storage (e.g., GlusterFS or |
| | cloud-based solutions) was used to ensure scalability and fault tolerance. |

Security and Access Control. Given the sensitive nature of handling malware, the experimental system should follow various security protocols, including role-based access control (RBAC), multi-factor authentication (MFA), and secure logging and monitoring. Table 13 shows the security protocols followed by the experimental system.

TABLE 13

| Security protocol | Details |
|---|---|
| Role-based | The study implemented RBAC to control access to the experimental system |
| access control | based on user roles. Only authorized users (e.g., administrators or analysts) were |
| (RBAC) | permitted to access specific components (e.g., database, analysis modules, etc.) |
| Multi-factor | The study enforced MFA for all users accessing sensitive areas within the |
| authentication | experimental system to prevent unauthorized access to malware samples, |
| (MFA) | behavior taxonomies, and analysis results. |
| Secure | The study enabled logging to record all activities within the experimental |
| logging and | system, including analysis execution, behavior extraction, and data access. Logs |
| monitoring | were stored, encrypted, and periodically reviewed to detect potential anomalies |
| | or unauthorized access. |

Continuous Update Implementation. To maintain the accuracy and effectiveness of the experimental system, regular updates to the taxonomy and software patches were necessary. The experimental system used a secure, automated update mechanism to apply software patches and updates to the behavioral taxonomy. All updates were digitally signed and verified to ensure their integrity, and users had the option to rollback in case of any issues. All updates were logged for audit purposes, with rollback options to maintain stability if any updates disrupted functionality or compatibility.

Integration with Current Security Tools. The utility of the experimental system could be enhanced by integrating the experimental system with current security tools, such as intrusion detection systems (IDS), security information and event management (SIEM) platforms, and threat intelligence solutions. The experimental system exposed APIs for data exchange with external tools, enabling the sharing of malware behavior data for IDS evaluation and cybersecurity testing. Data was formatted according to industry standards (e.g., STIX/TAXII) to maximize interoperability. The study also configured data export capabilities to allow the experimental system's analysis results to be transferred to reporting tools or visualized in dashboards, facilitating users to interpret and utilize the data for decision-making.

Scaling for Demand. The deployment of the experimental system accommodated varying workloads by dynamically scaling resources to maintain performance. The study set up load balancers to evenly distribute tasks across analysis modules, improving resource utilization and reducing latency during periods of high demand. In a cloud deployment, the study enabled elastic scaling to automatically allocate additional resources when analysis demands increased, ensuring that the experimental system could process large datasets without compromising performance.

Testing and Validation. Before full deployment, the experimental system underwent testing to verify functionality and security. The study conducted initial test runs with known malware samples to validate the experimental system, confirm behavior extraction, and ensure all system modules were working as expected. Initial tests could prove that behavior was reliably identified and reproducible with specified inputs. The study also conducted routine audits of the experimental system's deployment to ensure compliance with security standards and verify that isolation measures and sandbox configurations were correctly functioning.

Experimental Implementation. FIG. 4B shows various implementations of the analysis flows of the experimental system. In the study, the verifier module served as the execution environment for the malware, which could be a virtual machine or a bare-metal host.

The triage module was configured to perform lightweight analysis on malware to determine the need for more advanced analysis (e.g., concolic analysis) and speed up subsequent analysis modules. This approach facilitated the scaling of the experimental system to handle large datasets. However, there were scenarios where the triage module could be entirely or partially optional. First, if the user preferred that the raw malware be analyzed directly in later, more advanced modules, the triage module could be bypassed, which would provide a more detailed report but would require more time for advanced analysis. Second, in cases where the malware was highly obfuscated, rendering static analysis ineffective, the triage module could skip the static pipeline mode. Instead, the triage module performed dynamic analysis (e.g., dynamic pipeline mode), followed by advanced analysis (e.g., concolic analysis) without relying on static guidance.

Concolic analysis could be optional if the initial triage (e.g., running the malware) already exposed behaviors of interest. This could be the case for certain types of malware, such as ransomware, which typically prioritizes impact over stealth. The task generation module could be optional if a specific malware behavior did not need any environment customization or network communication to trigger. For example, ransomware did not need environment customization or network communication, so the task generation module did not need to generate corresponding tasks. The rewriter module could be optional if all the malware's instructions have been analyzed during the analysis phase (e.g., triage, concolic), eliminating the need to prevent unknown behaviors. Within the rewriter module, either static rewriting or dynamic rewriting could be optional if the other already removed all the unknown behaviors of the malware.

The behavior taxonomy module was configured as a benchmark to measure behavior coverage, and some of its internal configurations could be optional. For example, the hierarchical behavior scheme could be optional when focusing on only one level of abstraction. In addition, certain behavior categories could be optional when focusing on specific behavior types (e.g., network behaviors when studying communication patterns of malware). Further behavior modeling need not be limited to API-based implementations adopted by the experimental system. For example, behaviors could also be modeled using data-based approaches, such as occurrences of IoCs (indicators of compromise, e.g., URLs or sensitive files/registries), or artifact-based approaches, such as observed system artifacts (for dynamic behavior analysis) (e.g., generated files/network traffic), depending on the objective of the analysis. The modeling approaches could be used individually or in combination. Any modeling approaches could be adopted in the taxonomy module if the functionality of behavior modeling and benchmarking were achieved.

### CONCLUSION

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense but for explanatory purposes.

Disclosed are components that can be used to perform the disclosed methods and systems. These and other components are disclosed herein, and it is understood that when combinations, subsets, interactions, groups, etc. of these components are disclosed while specific reference of each various individual and collective combinations and permutation of these may not be explicitly disclosed, each is specifically contemplated and described herein, for all methods and systems. This applies to all aspects of this application, including, but not limited to, steps in disclosed methods. Thus, if there are a variety of additional steps that can be performed it is understood that each of these additional steps can be performed with any specific implementation or combination of implementations of the disclosed methods.

The following patents, applications, and publications, as listed below and throughout this document, are hereby incorporated by reference in their entirety herein.

What is claimed:

1. A system comprising:
a processor; and
a memory having instructions stored thereon for a pipeline operation to (i) extract malware behaviors through an analysis of real-world malware samples and (ii) utilize confirmed execution traces and required external inputs to replicate the traces accurately, wherein execution of the instructions by the processor causes the processor to:
receive malware computer-readable instructions as a malware sample;
determine whether the received malware sample requires a concolic analysis;
execute the concolic analysis in a first execution environment based on the determination, to determine concolic analysis results comprising a first set of malware behaviors represented through a first set of execution traces;
generate one or more external inputs based on the first set of execution traces in the concolic analysis results;
execute the received malware sample in a second execution environment to generate a second set of execution traces using the received malware sample and generated external inputs, wherein the second set of execution traces represents a second set of malware behaviors;
compare the second set of execution traces to the first set of execution traces to compare the second set of malware behaviors to the first set of malware behaviors to determine a set of verified behaviors for the received malware sample;
generate new malware computer-readable instructions by removing a portion of the malware computer-readable instructions or regenerating malware computer-readable instructions through a source code to generate a new rewritten malware sample, wherein the new rewritten malware sample is modified and compared in an iterative manner until a set of behaviors of the new rewritten malware sample matches the verified behavior via comparison of newly generated second sets of execution traces to the first set of execution traces; and
output the new rewritten malware sample, wherein the output is subsequently employed for studies on malware behaviors and/or generation of behavioral signatures for a detection of the malware and its variants.

2. The system of claim 1, wherein, in response to the newly generated second set of execution traces not matching the first set of execution traces, the execution of the instructions causes the processor to:
determine, via one or more AI modules, adjustments for concolic analysis and iteratively re-perform concolic analysis to re-generate a third set of execution traces, re-generate external input, and re-execute to re-generate a fourth set of execution traces in the second execution environment, and redo the comparison of the fourth set of execution traces to the third set of execution traces, until they match.

3. The system of claim 1, wherein the instructions to generate the new malware computer-readable instructions are executed by a binary rewriter and a source-code rewriter, and wherein the new malware computer-readable instructions are generated as a binary object, a source code object, or a combination thereof.

4. The system of claim 1, wherein the instructions by the processor to determine whether the malware sample requires concolic analysis comprise:
instructions to execute a triage operation having a pipeline operation configured to:
receive, via one or more processes, the malware sample;
modify, via the one or more processes, the malware sample, wherein the modification includes unpacking, disabling binary base, removing anti-analysis behaviors, or reducing loops;
determine, via the one or more processes, properties of the malware sample;
generate, via the one or more processes, reports of the modification and the determined properties; and
determine, via a rule-based engine, an initiation of the execution of the concolic analysis based on the modification and the determined properties.

5. The system of claim 4, wherein the pipeline operation further causes the processor to:
receive, via one or more AI modules, results of the modification and the determined properties;
determine, via the one or more AI modules, a request for (i) additional modifications of the malware sample, (ii) additional determinations of the properties of the malware sample, or (iii) a reinitialization of the pipeline operation, wherein the determined request follows predefined safety constraints and bounds; and
execute the pipeline operation, or a step thereof, based on the determined request.

6. The system of claim 1, wherein the pipeline is a static pipeline operation, an agentic AI pipeline operation, or a combination thereof.

7. The system of claim 1, wherein the execution of the concolic analysis causes the processor to:
receive the malware sample and configuration files to configure the first environment;
execute the malware sample in the first environment to explore multiple paths;
generate the first set of execution traces based on the execution of the malware sample, wherein the first set of execution traces includes one or more execution symbolic variables with constraints; and
solve the constraints to determine concolic parameters for the concolic analysis, wherein the concolic parameters are subsequently stored in a concolic database.

8. The system of claim 7, wherein the generation of one or more external inputs causes the processor to:
receive the first set of execution traces, and the one or more execution symbol variables therein, from the concolic analysis results;
receive one or more configuration parameters of the second execution environment; and
generate task files or network packets as the one or more external inputs, using the received one or more configuration parameters and the received first set of execution traces, or the execution symbol variables therein, wherein the generated task files or network packets configure the second set of malware behaviors represented by the second set of execution traces.

9. The system of claim 1, wherein the comparison of the second set of execution traces to the first set of execution traces causes the processor to:
determine a match between logic block sequences in the second set of execution traces and logic block sequences in the first set of execution traces;
determine a match between function calls in the second set of execution traces and function calls in the first set of execution traces; and
determine, a match between system events caused by the second set of execution traces and system events caused by the first set of execution traces.

10. The system of claim 3, wherein the rewriting of the malware sample causes the processor to:
disassemble, via the binary rewriter, the malware sample to locate executable instructions therein;
determine, via the binary rewriter, executed instructions within the executable instructions based on the second set of execution traces;
modify, via the binary rewriter, the executable instructions by rewriting unexecuted instructions from the executable instructions with exception-triggering instructions, wherein execution of the executable instructions in the malware sample terminates when reaching the exception-triggering instructions;
prompt, via the source-code rewriter, one or more AI modules with one or more implementation constraints to generate source code;
compile, via the source-code rewriter, generated source code to generate the new rewritten malware sample;
execute, via the source-code rewriter, the new rewritten malware sample to obtain the newly generated second set of execution traces that represent the set of behaviors of the new rewritten malware sample;
iteratively rewrite, via the source-code rewriter, the generated source code until the set of behaviors of the new rewritten malware sample matches the verified behavior; and
output the new rewritten malware sample, wherein the new rewritten malware sample is constrained to exhibit only the verified behavior.

11. The system of claim 1, wherein the execution of the instructions further causes the processor to:
categorize the new rewritten malware sample based on a complexity of the second set of malware behaviors.

12. The system of claim 1, wherein the execution of the instructions by the processor causes the processor to execute a second pipeline operation, the second pipeline operation having a subset of the pipeline operation.

13. The system of claim 11, further comprising:
a behavior database configured to store different behaviors of analyzed malware sample families.

14. The system of claim 13, wherein the behavior database is established based on the categorization of the malware sample based on a malware family value, a discovered date value, a complexity value, a behavior value, or a combination thereof.

15. The system of claim 14, wherein the behavior database is subsequently used in an AI or ML training pipeline configured to train one or more AI or ML models for malware detection, malware classification, and malware attribution.

16. The system of claim 1, wherein system includes an LLM agent.

17. The system of claim 1, wherein the system includes an LLM, AI model, a machine-learning model, or a combination thereof.

18. The system of claim 1, wherein the system is implemented and/or deployed in a distributed or cloud infrastructure.

19. A non-transitory computer-readable medium having instructions stored thereon, wherein execution of the instructions causes a processor to:
receive malware computer-readable instructions as a malware sample;
determine whether the received malware sample requires a concolic analysis;
execute the concolic analysis in a first execution environment based on the determination, to determine concolic analysis results comprising a first set of malware behaviors represented through a first set of execution traces;
generate one or more external inputs based on the first set of execution traces in the concolic analysis results;
execute the received malware sample in a second execution environment to generate a second set of execution traces using the received malware sample and generated external inputs, wherein the second set of execution traces represents a second set of malware behaviors;
compare the second set of execution traces to the first set of execution traces to compare the second set of malware behaviors to the first set of malware behaviors to determine a set of verified behaviors for the received malware sample;
generate new malware computer-readable instructions by removing a portion of the malware computer-readable instructions or regenerating malware computer-readable instructions through a source code to generate a new rewritten malware sample, wherein the new rewritten malware sample is modified and compared in an iterative manner until a set of behaviors of the new rewritten malware sample matches the verified behavior via comparison of newly generated second sets of execution traces to the first set of execution traces; and
output the new rewritten malware sample, wherein the output is subsequently employed for studies on malware behaviors and/or generation of behavioral signatures for a detection of the malware and its variants.

20. A method for a pipeline operation to (i) extract malware behaviors through an analysis of real-world malware samples and (ii) utilize confirmed execution traces and required external inputs to replicate the traces accurately, the method comprising:
receiving malware computer-readable instructions as a malware sample;
determining, whether the received malware sample requires a concolic analysis;
executing the concolic analysis in a first execution environment based on the determination, to determine concolic analysis results comprising a first set of malware behaviors represented through a first set of execution traces;
generating one or more external inputs based on the first set of execution traces in the concolic analysis results;
executing the received malware sample in a second execution environment to generate a second set of execution traces using the received malware sample and generated external inputs, wherein the second set of execution traces represents a second set of malware behaviors;
comparing the second set of execution traces to the first set of execution traces to compare the second set of malware behaviors to the first set of malware behaviors to determine a set of verified behaviors for the received malware sample;
generating new malware computer-readable instructions by removing a portion of the malware computer-readable instructions or regenerating malware computer-readable instructions through a source code to generate a new rewritten malware sample, wherein the new rewritten malware sample is modified and compared in an iterative manner until a set of behaviors of the new rewritten malware sample matches the verified behavior via comparison of newly generated second sets of execution traces to the first set of execution traces; and
outputting the new rewritten malware sample, wherein the output is subsequently employed for studies on malware behaviors and/or generation of behavioral signatures for a detection of the malware and its variants.
